(19) United States
(12) Patent Application Publication
(10) Pub. No.: US 2013/0240456 A1
(43) Pub. Date: Sep. 19, 2013

(54) DEVICE AND METHOD FOR LABEL-FREE SEPARATION OF MATERIAL USING MAGNETIC FIELD

(71) Applicant: THE GOVERNING COUNCIL OF THE UNIVERSITY OF TORONTO, (US)

(72) Inventors: Milica Radisic, Toronto (CA); Aarash Sofla, Toronto (CA); Ming-Yi (Anne) Hsieh, North York (CA)

(73) Assignee: THE GOVERNING COUNCIL OF THE UNIVERSITY OF TORONTO, Toronto (CA)

(21) Appl. No.: 13/800,162

(22) Filed: Mar. 13, 2013

Related U.S. Application Data
(60) Provisional application No. 61/610,075, filed on Mar. 13, 2012.

(51) Int. Cl. B03C 1/01

(52) U.S. Cl. CPC B03C 1/01
USPC 210/695; 210/223

(57) ABSTRACT

Devices and methods for label-free separation of material. A fluid-filled settling chamber is used for settling material by gravity. A fluid mixture comprising a target material and at least one non-target material is introduced into the settling chamber, where the target material has a paramagnetic property. A magnetic field is applied to the settling chamber sufficient to impede gravitational settling of the target material and not affect gravitational settling of the non-target material, in order to separate the target material from the non-target material.

### CROSS-REFERENCE TO RELATED APPLICATION

The present disclosure claims priority from U.S. provisional patent application No. 61/610,075, filed Mar. 13, 2012, the entirety of which is hereby incorporated by reference.

### TECHNICAL FIELD

The present disclosure relates generally to devices and methods for separation of material, in particular label-free separation of material by manipulating settling velocity of the material, such as by using a magnetic field. The present disclosure relates generally to devices and methods that may be suitable for use with cellular material and microfluidic systems.

### BACKGROUND

Chronic cardiovascular disease such as heart failure is increasing to epidemic levels, affecting 1 in 5 persons. The beating heart muscle has no significant ability to regenerate and the viable tissue remaining after an injury such as myocardial infarction is often insufficient to maintain adequate cardiac output [1]. Heart transplant is very often not an available or appropriate option. Thus there is a desire for alternative interventions [2, 3] through innovative therapeutic solutions enabled by tissue engineering. Since cardiomyocytes (CM), the beating cells of the heart, are terminally differentiated, they cannot be propagated from the heart biopsies of adult patients. Recent advances in the stem cell field enable CM to be derived from embryonic stem cells (ESC) [16] or induced pluripotent stem cells (iPSC) [29]. However, engineering advances are typically required to enable label-free separation of these cells from heterogeneous populations in a cost-effective manner.

Proper methods for the separation of CM, derived from ESC or iPSC may contribute to the success of any therapeutic tissue engineering approach since the presence of undifferentiated cells can lead to teratoma formation upon implantation. Conventional methods for isolation of CM at relatively high purity and yield have included the use of markers and/or labels.

Prior to the recent discovery of a signal regulatory protein SRP1α (SIRPA) as a CM surface marker [4], all of the available cardiac markers were intracellular proteins, thus antibody staining or genetic labeling had to be used for cell isolation. The antibody staining of intracellular markers such as contractile proteins requires cell permeabilization which unfortunately renders the cells non-viable and useless for cardiac therapy. On the other hand, genetic labeling of cells for clinical applications cannot be performed in humans due to ethical concerns. A mitochondrial dye, tetramethyl rhodamine methyl ester (TMRM), was reported effective in labeling and enrichment of CM [5]; however cells labeled with fluorescent probes cannot be used for clinical applications due to the unknown long-term effect of these organic molecules in humans. Although the newly identified SIRPA [4] acts as a marker of cardiomyocytes derived from human pluripotent stem cells, the wide applicability of the SIRPA antibody has yet to be determined. In addition, separation of cells for clinical application using mouse-derived antibodies may cause sensitization in patents and development of anti-mouse antibodies [19].

Other separation approaches, such as dielectrophoresis [30], have not yet been extensively studied with CM due to the fact that electrical fields can affect these electrically excitable cells.

Isolation methods that rely on inherent physical properties of cells have been used for label-free separation of cells. For example, Murthy et al. [6] used a sieve-like microfluidic device to demonstrate the feasibility of separating enriched subpopulations of neonatal rat heart cells, myocytes and non-myocytes on the basis of size. However, the focus of their filter-style approach was the separation of the smaller non-myocytes from the heterogeneous cardiac cell suspension. The high purity enrichment of CM from other cell types such as fibroblasts (FB) remains challenging because of the dimensional similarity of the suspended CM to other cell types, including large fibroblasts present in native heart isolates [31].

Another set of techniques relies on differential adhesion properties. In native heart isolates, CM is a cell type that typically takes the longest time to attach to the surfaces of tissue culture plates. Non-myocytes, such as fibroblasts, typically take significantly less time. These characteristics form a basis of an enrichment technique called pre-plating. The native heart isolate is incubated in a tissue culture plate for typically 1 hr, during which fibroblasts typically preferentially adhere to the surface of the tissue culture plate and CM typically remain in suspension. If these steps are sequentially repeated, enrichment of CM to over 80% may have been achieved [32]. Although simple, this technique is non-specific and leads to the loss of cell viability as many pre-plating steps are repeated in sequence.

### SUMMARY

In some example aspects, there is provided a device for label-free separation of material that may include: a fluid-filled settling chamber for settling material by gravity, the settling chamber having an inlet for introducing a fluid mixture comprising a target material and at least one non-target material, the target material having a paramagnetic property; wherein a magnetic field may be applied to the settling chamber sufficient to impede gravitational settling of the target material, and not affect gravitational settling of the non-target material, in order to separate the target material from the non-target material.

In some example aspects, there is provided a method for label-free separation of material, where the method may include: introducing into a fluid-filled settling chamber a fluid mixture comprising a target material and at least one non-target material, the target material having a paramagnetic property; applying a magnetic field to the settling chamber; allowing the non-target material and the target material to settle by gravity, wherein gravitational settling of the target material is impeded by the magnetic field; and separating the target material from the non-target material.

### BRIEF DESCRIPTION OF THE DRAWINGS

Reference will now be made to the drawings, which show by way of example embodiments of the present disclosure, and in which:

FIGS. 1A-C show schematic diagrams illustrating the operation of an example of the disclosed methods and devices;

FIG. 2A shows schematic diagrams illustrating an example of the disclosed devices;

FIG. 2B shows an image of an example of the disclosed devices;

FIG. 2C shows a schematic diagram illustrating an example arrangement of magnets in an example of the disclosed devices;

FIG. 3 shows example results of myoglobin quantification in cells, specifically in mouse fibroblasts (m-FB), mouse neonatal cardiomyocytes (m-neo CM) and mouse adult cardiomyocytes (m-adult CM);

FIGS. 4A and 4B show example magnetic property measurements of mouse neonatal cardiomyocytes and fibroblasts;

FIGS. 5A-5D show example results of metmyoglobin induction using sodium nitrite in neonatal rat CM;

FIGS. 6A-6C show example expression of cardiac Troponin T and myoglobin in neonatal rat CM;

FIGS. 7A-7C show example expression of cardiac Troponin T and myoglobin in differentiating mouse ESC;

FIGS. 8A and 8B show example expression of cardiac Troponin T and myoglobin in differentiating human ESC;

FIGS. 9A-9D show example viability of cells after NaNO₂ treatment and cell separation;

FIGS. 10A and 10B illustrate the balance of magnetic and gravitation force in an example of the disclosed devices;

FIG. 11 shows example results illustrating the correlation between input cardiomyocyte percentage and output percentage during separation of cells in an example of the disclosed devices;

FIGS. 12A and 12B show example results illustrating the viability of adult mouse CM after separation using an example of the disclosed devices;

FIG. 13 shows an example of a theoretical velocity profile of flow in an example channel;

FIG. 14 shows example results illustrating induction of paramagnetic properties in adult mouse CM;

FIGS. 15A-15C show example results of simulations illustrating forces and velocities experienced by material in an example of the disclosed devices;

FIGS. 16A-C show an example separation device having a horizontal configuration;

FIGS. 17A and 17B illustrate example magnetic fields applied across the example device of FIGS. 16A-16C;

FIG. 18 is a table listing example parameter values used for simulation of the example device of FIGS. 16A-16C;

FIGS. 19A-19C illustrate simulation results for particles at different starting positions in the example device of FIGS. 16A-16C;

FIGS. 20A-20C are images from an example study of the example device of FIGS. 16A-16C;

FIGS. 21A-21D show example results illustrating enrichment using the example device of FIGS. 16A-16C;

FIG. 22 is a table showing sequence listings of example qRT-PCR primers used in the studies of FIGS. 21A-21D;

FIGS. 23A and 23B are charts illustrating the viability of cardiomyocytes after treatment with NaNO₂ and after passing through the example device of FIGS. 16A-16C;

FIGS. 24A-24C are charts illustrating the expression of SIRPA in rat cardiomyocytes;

FIGS. 25A and 25B are charts illustrating quantification of myoglobin and gene expression in neonatal rat cardiomyocytes;

FIGS. 26A and 26B are images of cells with and without having been separated by the example device of FIGS. 16A-16C;

FIGS. 27A-27D illustrate the removal of red blood cells from cardiac cells;

FIGS. 28A-28D are immunostained images showing spatial expression of myoglobin in a neonatal rat heart;

FIGS. 29A-29C are charts illustrating the compartmental expression of myoglobins in the neonatal rat heart;

FIGS. 30A and 30B show example results illustrating myoglobin and cardiac Troponin T expression in human ESC-derived cardiomyocytes;

FIG. 31 shows example results illustrating myoglobin and cardiac Troponin T expression in human ESC-derived cardiomyocytes at different developmental stages; and

FIG. 32 shows example myoglobin protein expression in human ESC-derived cardiomyocytes at different developmental stages.

It will be noted that throughout the appended drawings, like features are identified by like reference numerals.

### DETAILED DESCRIPTION

Heart disease and stroke, the principle components of cardiovascular diseases, are the first and the third, respectively, leading cause of death in the United States accounting for nearly 40% of all death, surpassing those attributed to cancer [49]. Early encouraging proof of principle preclinical studies of cell-based cardiac repair employing cardiomyocytes showed implanted cells formed stable intracardiac grafts, retained cardiac phenotype, and resulted in the improved ventricle function [50-52]. However, primary healthy CM cell sources from human myocardium are not widely available, resulting in therapeutic challenges. Conventional protocols for guided differentiation of human pluripotent stem cells typically do not result in a homogeneous cell preparation of pure CMs [16, 53-55].

In addition to the technical challenge pertaining in obtaining purified CM without genetic or antibody labeling, the use of gene labeling may present an additional regulatory hurdle and the currently limited number of fluorophore-conjugated antibodies (Abs) for CM cell surface antigen markers may impede clinical processing [56-57]. Studies in biological (e.g., gene expressing profiling), pharmaceutical (e.g., drug screening), and therapeutic applications may thus be hindered. As such, it may be useful to develop translational label-free CM purification techniques.

Various CM enrichment methods have been reported based on the conventional phenotyping methods. They can be categorized into three general approaches: physical properties-based [5, 58], biological [59] or genetic properties [60-63], and cell intracellular tagging [64] or surface antigen labeling [4, 65]. Although purification based on density, size, or differential adherence to plastic may be relatively easy to perform, inexpensive and fast, it typically has low specificity and yield only relative depletion or selection. Drug resistance typically requires controversial genetic modification [66] and immunophenotype typically relies on invariability across cell lines, or CM developmental stage and species-specific surface markers [40, 67].

A separation method that may achieve higher purity, may be applied across species, and/or may use clinically relevant material would be useful, for example in order to realize the potential for regenerative cell therapy. In various examples and embodiments, the present disclosure provides methods and devices for separating target cells, such as CMs. The present disclosure may be suitable for clinical applications and/or cardiac tissue engineering, for example.

Proper methods for separation of CM, derived from ESC or iPSC, may contribute to the success of any therapeutic tissue engineering approach. Using engineering principles to achieve high efficiency label-free separation of CM may be useful, even when the CM surface markers are identified, as expensive antibodies for labeling surface markers may not be required. Furthermore, use of mouse-raised antibodies for cell separation in clinical applications may induce sensitization in patients and generation of anti-mouse IgGs [19] and therefore may not be desirable for labeling purposes.

Magnetic properties inherent to cardiomyocytes may be useful for isolation purposes.

CMs typically contain a relatively high amount of iron due to the presence of myoglobin. Under typical physiological conditions, myoglobin contains Fe²⁺. Upon treatment of CM with molecules such as NaNO₂, the cells can be rendered transiently paramagnetic by oxidation of myoglobin to metmyoglobin. Metmyoglobin consists of a backbone of eight helices wrapping around a central pocket containing a prosthetic protoheme group, a stable compound of ferric iron, Fe³⁺[33]. Metmyoglobin is paramagnetic from the isolated coordination complex with an unpaired d-electron [34]. In principle, the realignment of the unpaired electrons in the ferric iron in the direction of an externally applied magnetic field should direct the paramagnetic CM to move along the magnetic field gradient.

Magnetic separation has been successfully implemented for the identification and isolation of red blood cells (RBC) by taking advantage of the high level of iron in hemoglobin. Zborowski et al. used a magnetic field of 1.4 T, and mean gradient of 0.131 T/mm and showed that separation based on the magnetic properties of RBC is possible [7]. Han and Frazier, through a series of papers, reported magnetophoretic separation of RBC [8-10, 35]. Huang et al. developed a multi-step microfluidic system for the isolation of nucleated red blood cells (NRBC) from blood of pregnant women [11]. The first module in their device depleted the non-nucleated RBC. The magnetic module of their device then separated the white blood cells from NRBCs with purity of over 99.90%.

Other approaches, such as capture of beads by magnetotactic bacteria, to directly and actively transport the beads along the magnetic field lines have also been reported [36]. However, this approach may not be applicable to CM since CM have limited surface markers and typically cannot be selectively attached to magnetophoretic bacteria.

Conventional magnetophoretic devices, such as described above, typically cannot be applied to the separation of CM from heterogeneous cell preparations since the amount of iron in CM is about 1000 times less than the amount of iron in RBCs. Thus, it has been conventionally thought that CM cannot be isolated from heterogeneous cell populations using their magnetic properties and that only RBCs are suitable for this kind of separation [20].

After collagenase digestion, the heart isolate consists of CM, FB, smooth muscle cells (SMC) and endothelial cells (EC). The ratio of these cells in the native neonatal rat heart after collagenase digestion, as an example, may be about 47% CM, 48% FB, 3% SMC and 2% EC [12, 13]. Myoglobin is found in both CM and SMC. However, the Mb content in SMC (˜0.2 mg/g wet weight) is significantly smaller than in CM (2.6-5.4 mg/g wet weight), due to the high demand for oxygen in contracting CM.

In the present disclosure, a microfluidic approach for label-free magnetic separation of cardiomyocytes (CM) is presented. The higher amount of iron found in myoglobin (Mb) in CM when compared to the iron level of other cardiovascular cells may be exploited for separation purposes. Since myoglobin content was found to vary in different types of cardiomyocytes (e.g. atrial vs. ventricular) and at different developmental states, the present disclosure may allow for separation and isolation of different sub-types of cardiomyocytes as well as the cardiomyocytes of different maturation states in a label-free manner.

In the present disclosure, example studies have demonstrated that the non-magnetic CM may be rendered paramagnetic by treating the cells with a solution of NaNO₂ for a known amount of time. In example studies, the amounts of myoglobin in CM, as well as the magnetic susceptibility of the treated CM were measured. The presence of metmyoglobin upon treatment with NaNO₂ was also studied. An example of the disclosed devices was used to separate the desired CM and the resulting enrichment of this CM population was measured.

Although the present disclosure makes reference to cardiomyocytes and myocytes as target cells, it should be understood that any other suitable cells (e.g., any other cells that have a paramagnetic property or that can be treated to have a paramagnetic property) may be target cells. Although the present disclosure makes reference to a single type of target cells, it should be understood that more than one type of cells (e.g., two different cell types both having paramagnetic properties) may be targeted.

In some examples, the present disclosure may be suitable for separating cells having different levels of paramagnetic properties, such as for separating cells having a lower paramagnetic property from cells having a higher paramagnetic property.

The present disclosure may also be suitable for separating target biological material other than cells (e.g., cell components).

The present disclosure may also be suitable for separating target non-biological material, including any target particles having a paramagnetic property.

In some examples, the target material may be biological, non-biological or a combination thereof. Similarly, the non-target material may be biological, non-biological or a combination thereof.

### Example Device

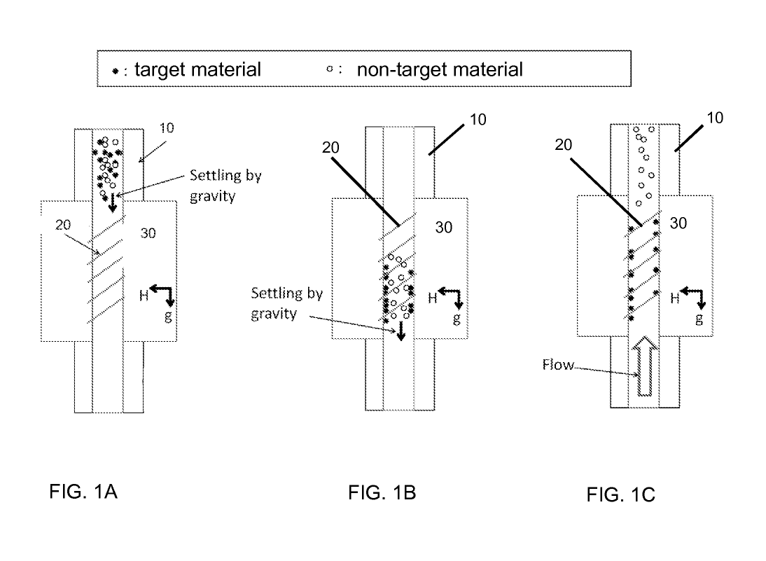

FIGS. 1A-C and 2A-C illustrate an example of the disclosed devices for label-free separation of material, and the operation of the example device. In the example shown, the example device is used to separate one type of paramagnetic cells (e.g., CM) from one or more non-paramagnetic material (e.g., non-paramagnetic cells or other biological debris). However, other target material may be separated using the example device.

The example device comprises a settling chamber 10, in this example a vertically-oriented microfluidic column or tube. The settling chamber 10 may be fluid-filled and allow for settling of material by gravity. By allowing the material to settle by gravity, rather than moving the material by fluid flow (such as in a horizontal microfluidic channel), it may be possible to take advantage of the small paramagnetic property of CM (since fluid flow in a microfluidic channel typically is too strong for CM to be affected by a magnetic field).

In this example, the settling chamber 10 includes an inlet, which may be located at an upper portion, for introducing a mixture of material. The mixture of material may include the target material having a paramagnetic property, and one or more non-target materials.

The example device may be suitable for separation of myocytes from a heterogeneous mixture of cells. The example device may employ gravity, hydrodynamics and magnetic properties of the target and non-target cells such that upon application of a magnetic field, CMs (which have paramagnetic properties) remain in the column while fibroblasts and other non-myocytes travel out of the column. The example device may be used for separation of other target paramagnetic material (e.g., different paramagnetic particles, paramagnetic sub-cellular components, other paramagnetic cells and clusters of cells, and paramagnetic molecules and assemblies) from non-target non-paramagnetic materials in other applications.

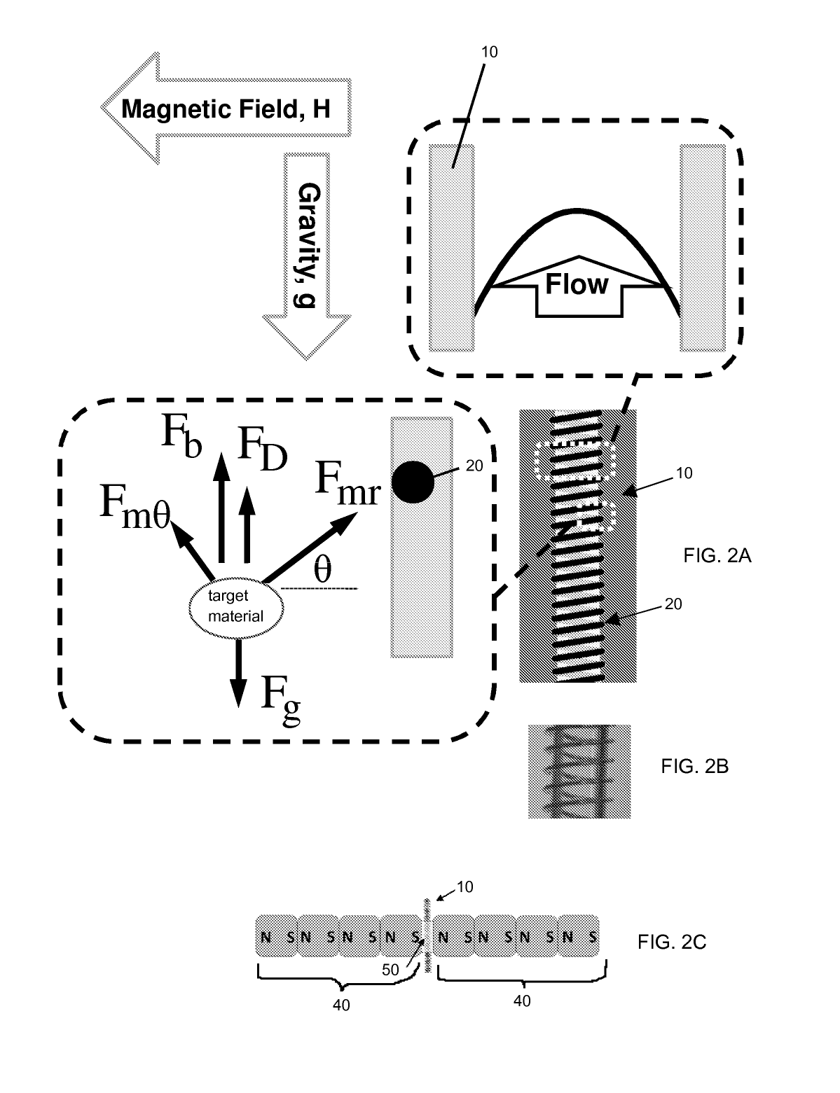

A magnetic field may be applied to the settling chamber 10. In this example, the magnetic field may be applied through the use of a metal coil 20 (in this example a nickel wire). The nickel wire may be wrapped around the circumference of the settling chamber 10 (see also FIGS. 2A and 2B). Permanent magnets, solenoids, electromagnets and other suitable devices may be used to apply the magnetic field. The settling chamber 10 may be placed in a vertical position between the permanent magnets. The nickel wire may be supported by a plastic support 30 (e.g., made of polydimethyl siloxane).

The applied magnetic field may be sufficiently strong to impede settling of the target material by gravity while having little or no effect on the settling of the non-target material by gravity. This may allow the target material to be separated from the non-target material.

In the example shown, the target material is sufficiently attracted to the wall of the settling chamber 10 due to the magnetic field from the metal coil 20, such that the target material is substantially moved towards the inner wall of the settling chamber 10, where the target material is less affected by flow of liquid in the settling chamber 10. In the example of FIG. 1C, fluid flow is introduced into the settling chamber 10 to wash out the non-target material. Because the target material is moved towards the inner wall of the settling chamber 10, the target material is less affected by the fluid flow and may not be washed out.

In other examples, the magnetic field may be sufficiently strong to attract and hold the target material against the inner wall of the settling chamber, such that the target material is rendered substantially immobile. In such a situation, the non-target material may be allowed to settle to the bottom of the settling chamber 10, where the non-target material may be removed (e.g., at an outlet located near the bottom portion of the settling chamber 10). Any suitable techniques for removing the non-target material may be used.

After all or sufficiently most of the non-target material has been removed from the settling chamber 10, the target material may be removed. Removal of the target material from the settling chamber 10 may be by, for example, removing the applied magnetic field and allowing the target material to settle or be washed out. Any other suitable techniques for removing the target material may be used.

In some examples, the target material may be immobilized inside a magnetic porous or fibrous support, or inside a cluster of columns, for example.

The example device is further described with reference to FIGS. 2A-2C. FIG. 2A shows a schematic of the example device. FIG. 2A illustrates the gravitational force (F_{g}), drag (F_{D}), buoyancy (F_{b}) and magnetic force (Fₘᵣ, F_{mθ}) experienced by a paramagnetic particle in the example device. As shown in FIGS. 1A-1C, such forces were combined in the example device in such a way that upon application of the magnetic field, the target material (in this case paramagnetic CM) remained in the device while non-target material (in this case fibroblasts and other non-myocytes) traveled out of the device.

In this example, the device may be fabricated by embedding a core inside polydimethylsiloxane (PDMS). The core may be made by wrapping a nickel wire about 69 μm in diameter around a stainless steel rod. The rod may be coated by an anti-sticking Teflon® spray before the wrapping of the nickel wire. The rod length in this example may vary from about 15 mm to about 30 mm and the diameter may vary from about 300 to about 1200 μm (e.g., about 700 μm), depending on the design and/or application, for example. FIG. 2B shows an image of an example core prior to embedding inside PDMS.

It should be understood that other dimensions may be used. For example, where the disclosed device is used for batch separation of target and non-target material, a longer setting chamber may allow more material to pass through and be separated in a single batch. The diameter may also be varied in order to allow separation of larger materials, for example. In other examples, the disclosed device may be adapted for flow-through separation of target and non-target material.

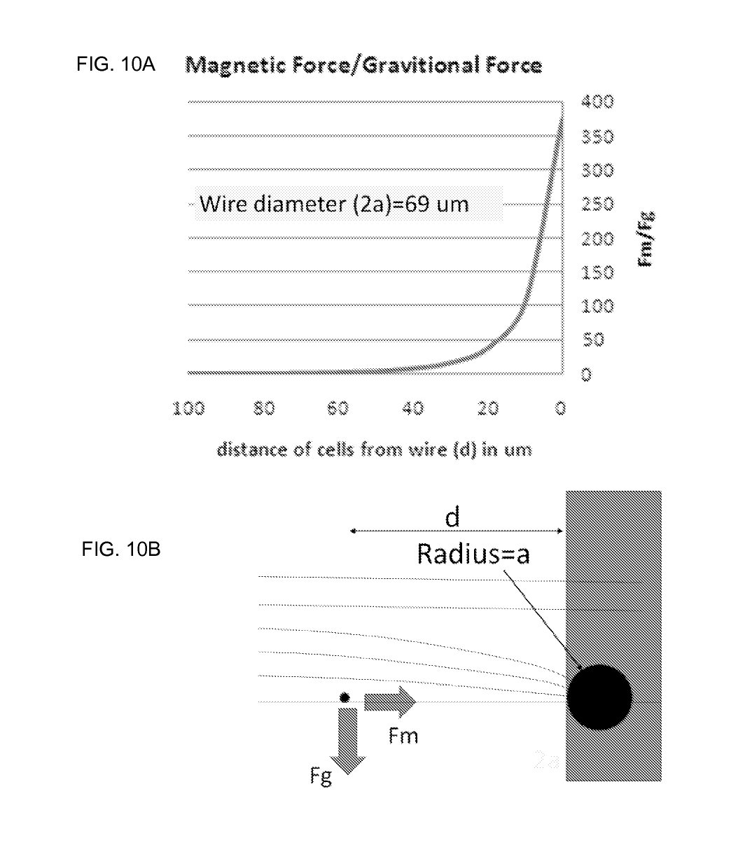

In general, a narrower settling chamber may be suitable where the target material is less paramagnetic, in order for the target material to be located within the range where the magnetic field may have an effect on the settling velocity of the target material. As illustrated in FIGS. 10A and 10B, and described further below in the present disclosure, the strength of the attractive force of the magnetic field drops as the distance from the magnetic field source (e.g., a metal wire) increases. Thus, a settling chamber that is too wide may result in a portion of the target material being insufficiently affected by the magnetic field to be separated from the non-target material. Conversely, a wider settling chamber may be used for a more paramagnetic target material. As well, a wider settling chamber may be used where the target material and/or the non-target material are relatively large. For example, where the target material and/or the non-target material include particles having a diameter of 100 μm or more, a settling chamber having a diameter of 300 μm may result in the large particles becoming trapped and blocking settling of other particles, and a wider settling chamber may be used instead. In some examples, the suitable size of the settling chamber may be determined through appropriate calculations and/or experimentation.

As shown in FIG. 2C, a magnetic field may be applied to the example device by positioning one or more permanent magnets adjacent to the device. In this example, four permanent nickel-iron-boron magnets 40 (shown as four pairs) may be placed on either side of the device, in order to generate a desired magnetic field. A spacer 50 may be used to assist in positioning the magnets 40 adjacent to the device.

The example device illustrated in FIGS. 1A-C and 2A-C may be fabricated as follows. PDMS may be prepared by a 10:1 ratio of monomer to crosslinker according to the manufacturer's instructions. A mold may be degassed in a dessicator. The prepared PDMS may be introduced into the mold, with a central rod to form the hollow center, and placed in a convection oven at about 65° C. for about two hours, followed by overnight curing at room temperature. After curing, the rod may be removed. Fluid connections (e.g., for inflow and outflow of fluid) may be provided by tubing (e.g., Tygon® tubing) at end of the column, and may be sealed (e.g., with 5-minute epoxy).

A uniform magnetic field may be generated by positioning one or more permanent magnets adjacent to the device. In this example, four neodymium-iron-boron permanent magnets of cubic shape (approximately 12.7 mm×12.7 mm×12.7 mm) may be positioned, separated from four similar magnets by means of two spacers. Using such an arrangement, the field strength within the space between two magnets was measured to be about 1.23±0.05 T. In example studies, described further below, it was found that such an example device, with a settling chamber diameter of about 700 μm, resulted in satisfactory enrichment of adult CM. The column length within the space between the magnets may be about 15 mm.

The effect of applied magnetic field to impede gravitational settling of the target material may be calculated as described below. Although the calculations below use an example fixed value for the magnetic field, it should be understood that the strength of the magnetic field may be varied. While there may be a minimum amount of magnetic field strength necessary (e.g., to achieve sufficient magnetic attraction to overcome outflow), there may not be a maximum magnetic field strength.

Reference is now made to FIG. 2A, which schematically illustrates the magnetic and gravitation forces acting on a target material, in general. CM cells are described as example target material. However, similar analysis may be used for other target material.

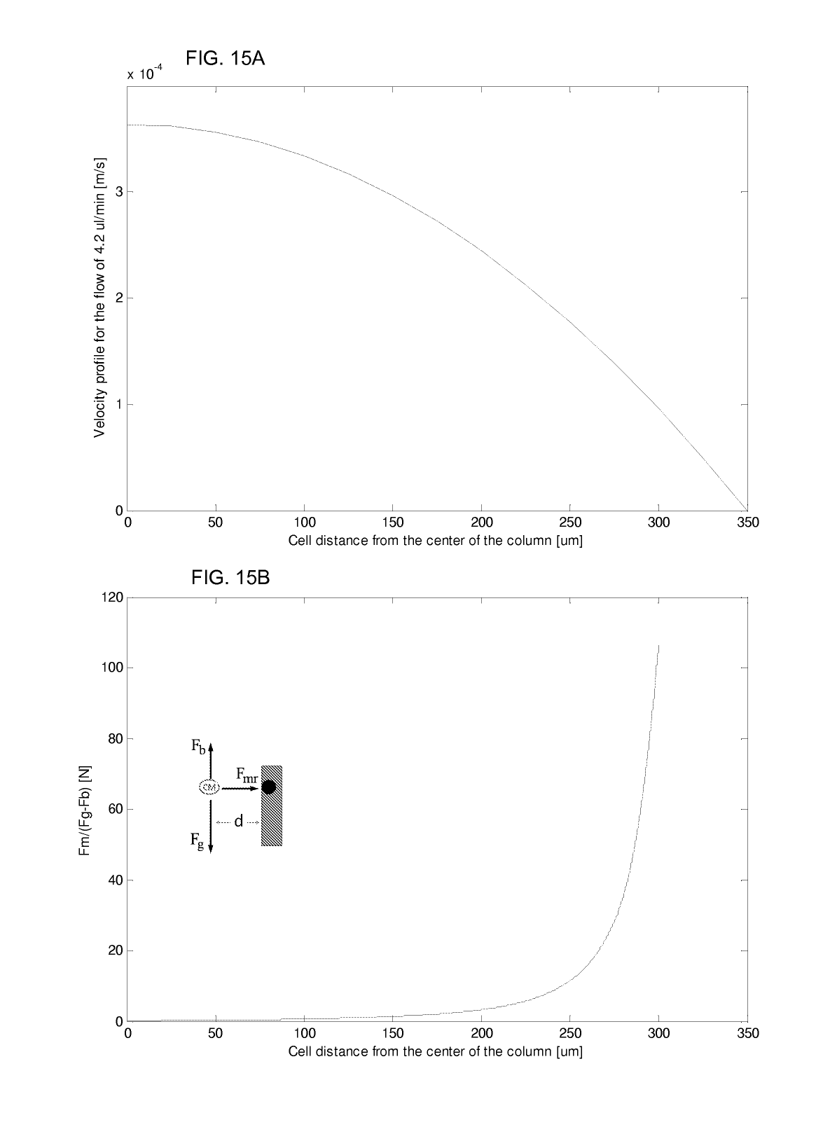

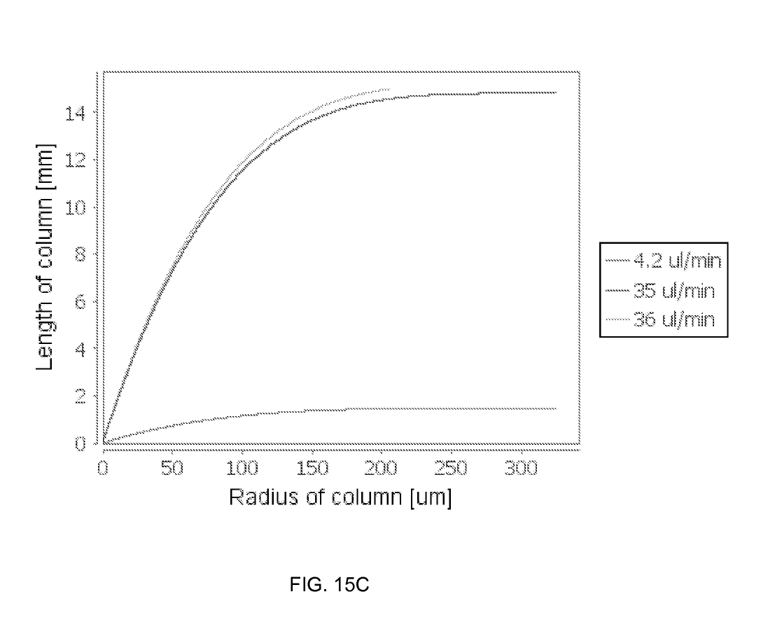

In the example device described above, the separation mechanism may be based on a high gradient magnetic separation method [18]. Magnetic force effects were used in conjunction with the settling velocity of the target material (in this case, paramagnetic cells) in the separation column in order to affect the target material trajectory and achieve capture of the target material in the column. In the example device, the settling chamber was oriented vertically, as a separation column. The media flowed from the bottom to the top and pushed material (both target and non-target) upward (that is, against the force of gravity). However, the magnetic field attracted the paramagnetic target material toward the boundary layer of the flow where the flow velocity was less than in the central parts of the column (described further with respect to FIG. 15A). Adjusting the flow rate such that the settling velocity of target material due to gravity and the magnetic field remained larger than the upward velocity of target material within the boundary layer of the fluid flow resulted in target material being trapped within the chamber while the rest of the material (e.g., non-myocytes) were carried out with the flow (see FIG. 1C). The target material, in this case CM, was then released from the column by increasing the rinsing flow rate.

In this example, relatively strong magnetic field and magnetic gradient were applied at or near the column wall. Calculations of an average flow rate and applied magnetic force for the paramagnetic particles inside the column are now discussed, to assist in understanding the effect of magnetic field gradient on the accumulation of the paramagnetic target material in an example vertical settling chamber.

Reference is again made to FIG. 2A illustrating the forces that may be experienced by a paramagnetic material that is travelling through the settling chamber.

The paramagnetic particle of FIG. 2A is shown in a fluid stream in the presence of a wrapped magnetized wire. The particle experiences magnetic, hydrodynamic and gravitational forces. The balance of forces which describes the particle motion is given by eq. (1):

\vec{F}=\vec{F}ₘ+\vec{F}_{D}+\vec{F}_{g}+\vec{F}_{b}, (1)

where \vec{F}ₘ is magnetic force, \vec{F}_{g} is gravitational force, \vec{F}_{b} is buoyancy, and \vec{F}_{D} is the drag force.

The magnetic force \vec{F}ₘ acting on a magnetic particle is proportional to the applied magnetic field H and magnetic field gradient ∇H:

Fₘ=μ₀V₀χₚH∇H, (2)

where μ₀ is the magnetic permeability of vacuum, Vₚ is the particle volume, and χₚ is the particle magnetic susceptibility. In order to examine the value of magnetic force \vec{F}ₘ and the boundary fluid flow required for accumulation of paramagnetic particles in the column, the trajectory of a paramagnetic particle moving as a result of flow in the vertical column under the magnetic field gradient may be calculated.

The general configuration of the particle motion problem and a 2D schematic of the particle control system utilized for modeling the targeting of the paramagnetic particle by the magnetic force arising from the magnet placed outside the column are represented in FIG. 2A [18]:

$$\begin{matrix}{F}_{mr} = \frac{- {μ}_{0} {kV}_{p} {M}_{S} {a}^{2}}{{r}^{3}} ( \frac{{M}_{S} {a}^{2}}{{r}^{2}} + {H}_{0} cos 2 θ ) & ( 3 ) \\ {F}_{m θ} = \frac{- {μ}_{0} {kV}_{p} {M}_{S} {H}_{0} {a}^{2}}{{r}^{3}} sin 2 θ & ( 4 ) \\ {F}_{g} = {ρ}_{p} {gV}_{p} & ( 5 ) \\ {F}_{b} = {ρ}_{f} {gV}_{p} & ( 6 ) \\ {F}_{D} = 6 π c η ( {v}_{f} - {v}_{p} ) & ( 7 )\end{matrix}$$

where k=χₚ−χ_{f} is the difference in magnetic susceptibility of the particles and media at room temperature, r is the distance of a particle from the nickel wire, a is the radius of the nickel wire, M_{S} is the saturation magnetization of wire, H₀ is the external magnetic field strength, η is the dynamic viscosity of fluid and ν_{f},νₚ represent the velocities of the fluid and the particle, respectively. In addition, ρₚ is the density of the particle, ρ_{f} is the density of the fluid media, Vₚ is the volume of the target material (in this case, CM), and c is the effective radius of the target material (in this case, CM).

The trajectory of the paramagnetic target particle, positioned in the center at the bottom of the column, may be calculated using equations (3), (5), (6) and (7) assuming that the particle is at the same level as the nickel wire (i.e., θ=0). In the example simulations described here, calculations and plotting were performed using Matlab. The initial velocity of the paramagnetic particle in the cylindrical column at an initial location S₀[X₀,Y₀] was set as ν₀=ν(S₀). Particle acceleration, A₀=A(S₀) at the initial location S₀[X₀,Y₀] may be calculated using the following equation:

$$\vec{A} = \frac{\vec{F}}{{m}_{p}} \qquad ( 8 )$$

where mₚ is the mass of the paramagnetic particle. At the second and, generally, n^{th} position, velocity, and acceleration may be calculated using the following equations:

S_{N}=S_{N-1}+Vₙ₋₁·t+½Aₙ₋₁·t² (9)

Vₙ=Vₙ₋₁+Aₙ₋₁·t (10)

Aₙ=A(Sₙ) (11)

Example simulation values for the parameters in eq. (3-7), for a typical experimental condition with a 700 μm diameter column are described in Table 1 below.

TABLE 1

| Variable | Name | Value | Unit |
|---|---|---|---|
| μ₀ | Vacuum permeability | 4π × 10⁻⁷ | H/m |
| k_{P} | Magnetic susceptibility of CM | 1.58 × 10⁻⁵ to | — |
| | | 7.11 × 10⁻⁸ | |
| k_{f} | Magnetic susceptibility of fluid | −0.9 × 10⁻⁵ | — |
| a | Nickel wire radius | 34.5 | μm |
| M_{S} | Saturation magnetization of nickel | 486 × 10³ | A/m |
| r | Distance of cell from the wire | 0-200 | μm |
| B₀ | External magnetic field | 1.23-1.25 | T |
| g | Acceleration of gravity | 9.98 | m/s² |
| θ | Angle to define the location of | — | Rad |
| | cell vs. wire | | |
| η | Dynamic viscosity of fluid | 0.001 | Ns/m² |
| ρₚ | Density of CM | 1060 | kg/m³ |
| ρ_{f} | Fluid density | 1000 | kg/m³ |
| c | Effective radius of CM | 7 to 22 | μm |

Equation (12) shown below may be used to compare the magnetic force, Fₘ, with the buoyancy and (gravitational force), F_{g}, of a paramagnetic material [18].

$$\frac{{F}_{m}}{{F}_{g}} = \frac{- {μ}_{0} {kM}_{S} {a}^{2}}{Δρ {g ( a + d )}^{3}} ( \frac{{M}_{S} {a}^{2}}{{( a + d )}^{2}} + {H}_{0} ) \qquad ( 12 )$$

where k=k_{C}−k_{f} is the difference of susceptibility of the material (in this example CM) and media at room temperature. The ratio of magnetic force to the gravitational force applied on a representative sodium nitrite-treated paramagnetic neonatal rat CM is plotted in FIG. 10A using parameter values from Table 1, where the effective radius of the CM, c, has a parameter value of 7 μm and the magnetic susceptibility of CM, kₚ, has a parameter value of 1.58×10⁻⁵. This example theoretical analysis shows that the magnetic force is relatively small, which may be due to the low magnetic susceptibility of the CM. This implies that the resulting velocity of the material toward the magnet may be much smaller than the material settling velocity which is expected to be between about 5 and about 10 μm/s for a given diameter of about 11-15 μm [28].

The settling velocity is the terminal velocity at which material (whether target or non-target) sink in the media. At that velocity, the gravitational force equals the opposing hydrodynamic drag force so the material travels downward at this constant velocity. Therefore, the flow rate should be relatively slow otherwise the target material may not be trapped in the column. For example, it has been found experimentally that a flow rate that is just slightly greater than the calculated settling velocity was sufficient. Therefore, the magnetic force was considered in conjunction with the settling velocity of the material.

As an example, the magnet attracts target material toward the boundary layer of the flow, where the flow velocity tends to be less than toward the centre. By adjusting the flow rate such that the settling velocity of target material due to gravity remains larger than the upward speed of target material within the boundary layer, target material may be trapped within the channel while non-target material may be carried out with the flow.

It should be understood that similar calculations and analysis may be made for other device configurations, simulation parameters and/or other target material, as appropriate.

For example, the settling chamber may be a settling column having a diameter in the range of about 10-10000 μm and a length of about 1-1000 mm. The strength of the applied magnetic field may be in the range of about 0.01-30 T. The flow rate of fluid, to remove the non-target material, may be in the range of about 1 nL/min-10 mL/min. It should be understood that these values are illustrative only and are not intended to be limiting. Values within or outside of these example ranges may be suitable for different applications.

### Example Studies

An example study is now described, using the example device described above with respect to FIGS. 1A-C and 2A-C. The example study describes the use of the example device for separation of cardiomyocytes (CM). The example study also describes an example of how a paramagnetic property may be introduced into CM.

Although example studies and results are presented here, it should be understood that these are provided as examples only and are not intended to be limiting. The present disclosure is not bound by such studies and is not reliant on the findings of such studies.

### Cell Isolation

Neonatal rat CMs were used to measure the amount of myoglobin and also to study the effect of NaNO₂ on cell viability and function. The cells were dissociated according to a standard isolation protocol [14, 21]. Briefly, neonatal (1-2 day old) Sprague-Dawley rats were first euthanized. The hearts were removed and quartered. Quartered hearts were digested in 0.06% (w/v) solution of trypsin (from Sigma, Canada) in Ca²⁺ and Mg²⁺-free Hank's balanced salt solution (HBSS) (from Gibco, Canada) overnight at 4° C. Then, collagenase II (from Worthington, USA at 220 units/mL) in HBSS was used to further digest the heart at 37° C. in a series of five 4-8 min digestions. After the last digestion step, the cells were centrifuged at 500 rpm for 5 min which ensured that cardiac cells were pelleted while red blood cells remained in the suspension. The cells were pre-plated in T75 flasks for 1 hr in an incubator in cardiac culture medium. The cells that remained unattached after 1 hr of pre-plating were considered CMs. The attached cells, cardiac fibroblasts, were expanded for up to 1 week and used as a negative control. The CM culture medium and fibroblast culture medium were substantially identical in composition, consisting of Dulbecco's Modified Eagle Medium (DMEM) with 4.5 g/L glucose, 4 mM L-glutamine, 10% certified fetal bovine serum (FBS), 100 U/mL penicillin, 100 μg/mL streptomycin, and 10 mM 4-2-hydroxyethyl-1-piperazineethanesulfonic acid buffer (HEPES).

### Isolation of Adult Mouse Ventricular Myocytes

Ventricular myocytes were obtained from 8- to 12-week-old adult YFP transgenic mice (129-Tg 7AC5Nagy/J, from Jackson Laboratory) of either sex using a suitable isolation procedure, such as described in [22]. Mice were heparinized (10 IU/g body weight) and 5 min later, anesthetised with 2.5% isoflurane as confirmed by the absence of pedal reflexes. Hearts excised via midline thoracic incision and transferred to ice-cold Ca²⁺-free Tyrode's solution [(mmol/L) 137 NaCl, 5.4 KCl, 1.0 MgCl₂, 0.33 NaH₂PO₄, 10 D-glucose, 10 HEPES, pH 7.4] were mounted on a 20-gauge blunted stainless steel canula and retrogradely perfused via aorta with 37° C. oxygenated Ca²⁺-free Tyrode's solution for 5 min, followed by collagenase (1 mg/ml, Worthington) for 8 min. Ventricular tissues were dissected out and transferred to and stored in Krebs-bicarbonate solution [(mmol/L) 120 potassium glutamate, 20 KCl, 20 HEPES, 1.0 MgCl₂, 10 D-glucose, 0.5 K-EGTA, and 0.1% bovine serum albumin, pH 7.4] at 4° C., with gentle trituration to dissociate CMs.

### Production of Mouse ESC-Derived CM

Mouse ES cell (mESC) line yc5/EYFP/MHC-neo was used in the study. As such, the cell line enables selection of CMs from mESC using neomycin selection. The cell line was transfected with an expression vector containing an α-myosin heavy chain promoter upstream of the neomyocin phosphotransferase gene (MHC-neo). The differentiation protocol was previously described by Zandstra et al [23]. Briefly, mESCs were maintained undifferentiated on gelatin (from Sigma, Oakville, Calif.) (0.2%)-coated tissue culture flasks in high glucose Dulbecco's modified Eagle's medium (DMEM; from Invitrogen, Burlington, Calif.) supplemented with 15% defined fetal bovine serum (from Gibco), 0.1 mM 2-mercaptoethanol (from Sigma), 0.1 mM nonessential amino acids (from Invitrogen), 1 mM sodium pyruvate, penicillin (50 IU/ml), and streptomycin (50 μg/ml) (from Invitrogen) with the addition of leukemia inhibitory factor (LIF, 1000 units/ml; from Millipore) in a humidified incubator with 5% CO₂ at 37° C. To initiate differentiation in bulk-stirred suspension culture, mESCs were dispersed into individual cells with trypsin and inoculated at a density of one million/10 ml differentiation medium (mESC culture medium without LIF) into a 250-ml Cellspin spinner flask (from Integra Biosciences, NH). The flask was stirred at 60 rpm and medium exchanged every 2 days. For mESC-derived CM antibiotic selection, on day 9 after the initiation of differentiation, medium was supplemented with G418 (400 μg/ml, from Invitrogen) to eliminate cells not expressing the neomycin resistance gene for another 9 days. The YFP-expressing CMs were then collected.

Production of hESC-Derived CM

CMs were differentiated as embryoid bodies from the Hes2 human ESC line according to a protocol developed by Keller and colleagues [16]. Briefly, for differentiation to the cardiac lineage, the following cytokines were used: days 0-1, BMP4 (0.5 ng/ml); days 1-4, BMP4 (10 ng/ml), bFGF (5 ng/ml) and activin A (3 ng/ml); days 4-8, DKK1 (150 ng/ml) and VEGF (10 ng/ml); after day 8, VEGF (10 ng/ml), DKK1 (150 ng/ml) and bFGF (5 ng/ml). Cultures were maintained in a 5% CO₂/5% O₂/90% N₂ environment for the first 10-12 days and were then transferred into a 5% CO₂/air environment. EBs were dissociated at Day 21 and saved for measurements.

### SQUID Measurements

Samples were prepared with a total of 3 million cardiac myocytes treated with 50 mM NaNO₂ in PBS on ice for 30 min. Upon centrifugation, 5 μL of cell pellet was collected and transferred to sample holder. The Superconducting Quantum Interference Device (SQUID, MPMS-5, from Quantum Design, San Diego, USA) was used to conduct DC magnetization measurements to characterize the myocytes. The holder was fixed in the center of a 20 cm plastic tube (straw) and the plastic tube was connected to the brass stick by polytetrafluoroethylene (PTFE) tape. It was then inserted into the detection sensor. The spatial position of the sample in the detection coil was adjusted to align the peak of the second-order gradiometer pick-up coil output voltage to the center of the scan length for uniform magnetization of the sample. Magnetic moments, M(H) in emu, were measured at 41 different applied magnetic field strengths (H) at 300K, from 0 to 10 KOe, followed by measurements from 10 to −10 KOe, and then −10 to 0 KOe, with triplicate measurements at each point.

### Myoglobin Quantification by ELISA

Cell lysates were prepared with NP40 Lysis Buffer ((mmol/L) 50 Tris-HCl, pH 7.4, 150 NaCl, 40 NaF, 0.5 Na₃PO₄, 1% NP40) supplemented with complete protease inhibitors without EDTA and 200 μM Na₃PO₄. To normalize the amount of myoglobin per number of CM, the cells in suspension were counted prior to lysis. Since myocardium is composed of a heterogeneous cell population, total CM number in the sample lysis was obtained by analyzing the percentage of the CM. Neonatal myocardium cells collected from enzymatic digestion were all spherical and vaguely distinguishable by shape or size distribution, therefore, the percentage of neonatal CMs in the cell suspension was determined by immunostaining of paraformaldeyde fixed cells for a cardiac marker Troponin I and flow cytometry as we have described previously [32]. The collected adult CMs were morphologically distinguishable rod-shaped cells in bright field microscopy. Thus, their percentage was quantified using hemocytometer by counting the rod shape cells (ratio of length to width >3).

Myoglobin determination by sandwich ELISA was performed according to the manufacturer's protocol (from Life Diagnostics). Briefly, the test samples were placed into microtiter wells pre-immobilized with monoclonal antibody directed against the myoglobin molecule. The polyclonal anti-myoglobin antibody conjugated to horseradish peroxidase was added in solution. The test samples were allowed to react simultaneously with the two antibodies, resulting in the myoglobin sandwiched between the solid phase and the enzyme-linked antibodies. After 60 min of incubation at room temperature, the wells were thoroughly washed to remove unbound HRP labeled antibodies. HRP substrate, tegramethyl-benzidine (TMB), was added to allow a development of color, with the intensity directly proportional to the concentration of myoglobin. The absorbance was measured spectrophotometrically at 450 nm using a plate reader (Apollo LB911, from Berthold Technologies).

### Metmyoglobin Evaluation Using Spectrophotometry

UV-vis measurements were made in cells lysed with NP40 Lysis Buffer, for 30 min on ice, with cell debris spun down at 13000 rpm for 10 min at 4° C. The lysates were collected and mixed with NaNO₂ solution (2.5 mM for up to 1 hr on ice) while NaNO₂-free solutions were used as controls. ND-1000 Nanodrop spectrophotometer (from Nanodrop Technologies, Inc., Wilmington, Del., USA) was used to collect absorption spectra from 200-700 nm.

### Flow Cytometric Evaluation of Troponin T and Myoglobin in Different Cell Populations

Analytical flow cytometry was performed on a BD FACS Calibur Flow Cytometer to assess the co-expression of cardiac Troponin T and myoglobin of native heart isolate, mESC-CM, and hESC-CM. Native heart isolates were collected after one pre-plating step, and mESC-CM and hESC-CM EBs were enzymatically dissociated in collagenase B (1 mg/ml, from Roche Diagnostics) and dispase I (2 U/ml, from Roche Diagnostics) at 37° C. for 2 hrs. ESC differentiation medium was added to ESC cells and the embryoid bodies were dissociated to single cells by trituration. Dispersed cells were fixed in 4% paraformaldehyde at room temperature for 20 min, washed with PBS, and permeabilized by cold methanol for 2 min. Cells were pelleted in centrifuge tubes, rinsed in 5% FBS in PBS, and incubated in primary antibodies on ice for 30 min (1:250 dilution factor) followed by rinsing and incubation in secondary antibodies on ice for 30 min (1:100 dilution).

The antibodies were diluted in 5% FBS in PBS. Monoclonal mouse anti-cardiac troponin T (cTnT; from ThermoScientific) and rabbit anti-myoglobin (Mb; from Abcam) antibodies were used to examine the target protein expression. Secondary antibodies included a Cy5-conjugated donkey anti-mouse IgG (from Millipore) and FITC-conjugated goat anti-rabbit IgG (Jackson Immuno Research). Data acquisition and analysis were conducted on the FACS workstation to determine the co-expression of cTnT and Mb in different cell types.

### Effect of NaNO₂ Treatment on Cell Viability

Neonatal rat CMs were treated with HBSS containing 5, 10, 25 or 50 mM NaNO₂ for 30 min on ice, the conditions known to maintain the viability of isolated CM in a single cell suspension [15]. Cell viability was determined immediately after treatment. In addition, the cells were cultivated in 3D for 7 days as described below.

### Cell Viability

Live/dead staining was performed by incubating the cells or constructs in a solution of carboxyfluorescein diacetate-succinimidyl ester (CFDA-SE, 10 μM, from Molecular Probes) and propidium iodide (PI, 2.5 μg/mL, from Molecular Probes) for 30-45 minutes at 37° C., according to the manufacturer's protocol (from Molecular Probes, Burlington, Canada). The cells were imaged using a fluorescent microscope (Leica DMIRE2, from Wetzlar, Germany). The live/dead staining was performed in CM subjected to NaNO₂ concentrations of 5, 10, 25 and 50 mM, dissolved in HBSS, and the negative control (HBSS without NaNO₂) at 4° C. for 2.5 hrs. Following treatment, the cells were washed in HBSS, and incubated for 5 hrs in 37° C./5% CO₂ incubator. Non-viable cells with compromised cell membranes could be identified by red fluorescence due to binding of PI to their nuclei, while viable cells converted CFDA-SE to the green fluorescent dye CFDA by esterase-mediated cleavage.

### 3D Culture of Neonatal Rat Cardiomyocytes

To assess the ability of the NaNO₂ treated cells to form functional 3-dimensional tissues, the cells were seeded onto porous collagen scaffold (1 cm×0.5 cm×300 um thick, from Ultrafoam) at a density of 10⁸ cells/cm³ and cultured in neonatal rat CM medium for 7 days.

### Electrical Excitability Parameters

Contractile properties of CMs were measured by field stimulation in an electrical stimulation chamber consisting of two parallel carbon electrodes spaced 1 cm apart as described in [24]. Stimulation was provided by an external electric stimulator (Grass s88x). Using monophasic pulses of 2 ms duration and frequency of 1 pulse per second, the excitation threshold (minimum voltage at which synchronous contractions of 75% of the tissue in the field of view can be observed) was first determined. Then the maximum capture rate (maximum beating frequency) was determined at 200% of the determined excitation threshold voltage.

### Immunostaining for Cardiac Troponin T

Immunostaining was performed to assess the phenotype of cultured cells. The cells were first fixed in 4% (w/v) paraformaldehyde in PBS for 15 min at room temperature. Then, the cells were permeated and blocked in 5% FBS and 0.25% Triton X100 in PBS for 1 hour. Next, the sample was incubated in primary antibody Troponin T (Mouse, clone 13-11, 1:200 dilution, from Fisher Scientific) overnight at 4° C. Followed by three washes, the samples were then incubated with Alexa 488-conjugated anti-mouse IgG secondary antibody (1:200 dilutions, from Sigma). The sample was then imaged with a fluorescence microscope (Olympus IX2-UCB, Canada).

### Cell Separation

Isolation was carried out using the example device described above. The strength of the applied magnetic field and/or the flow rate of fluid to wash out the non-target cells may be determined using appropriate calculations and/or empirical methods.

For the enrichment tests, adult mouse heart cells were mixed with primary neonatal mouse fibroblasts at different ratios ranging from 15% to 85%, to study the effect of initial CM percentage on final enrichment. Cell concentration was determined using a hemocytometer. The concentration of the cell sample also varied from low (about 0.2 million/mL) to high (about 5 million/mL) to track the effect of sample concentration on the enrichment results. The cells were treated with NaNO₂ in the concentration from 2.5 mM to 50 mM for 20 min on ice using media consisting of Ca²⁺- and Mg²⁺-free Hanks Balanced Salt Solution with 30% FBS. Sodium nitrite was kept in solution during the entire separation process to ensure that metmyoglobin is present in the cells during separation. Initial studies demonstrated that 0.2 million cells/ml and 2.5 mM of NaNO₂ resulted in the highest enrichment, thus they were pursued in all subsequent studies.

To load the cells into the column, about 20 μL of the sample was withdrawn by a pipette tip from the Eppendorf tube. The tip was then extracted from the pipette and placed on the top of the column. The mixture was either withdrawn into the column by a syringe pump that was connected to the bottom of the column, or just by settling of the cells into the column as a result of gravity. Upon settling, the flow of 4.2 μl/min was applied from the bottom of the column to rinse the fibroblasts out while keeping CM in the column. A pipette tip was inserted into the top of the column to collect the rinsing flow. After 200 μL, the flow was stopped, a new pipette tip was inserted and the flow rate was increased to 144 μL/min. As a result, the trapped cells inside the column were pushed out, into the pipette tip.

After collecting about 200 μL of media into the pipette tip, the tip was removed and emptied into a well of a 12-well plate that was already coated with a solution of 10% Matrigel and 90% plating media for adult CM. Plating media, 2 mL, was added to the well and suspended few times. The fluid was then split into two volumes of 1 mL each in new wells. One well was used to count the enrichment of the cells and to study the cell viability right after the test, while the other well was incubated for about 24 hours to study the viability of the cells upon separation and culture. Bright field imaging was used to count the number of CM and fibroblasts, where rod-shaped cells were considered CM.

### Viability and 2D Culture of Adult Rat Cardiomyocytes

Adult mouse CMs were isolated and suspended in Kraft Bruhe (KB) solution at 4° C. The KB solution consisted of 120 mM K-glutamate, 10 mM KCl, 10 mM KH₂PO₄, 2 mM MgSO₄.7H₂O, 10 mM Taurine, 5 mM Creatine, 10 mM HEPES, 10 mM Glucose, 0.5 mM EGTA, 0.10% Bovine Serum Albumin (BSA) and a final pH of 7.3 adjusted with KOH. The adult mouse CMs in KB solution were then split into three groups. Each of these three KB solutions containing adult mouse CMs was then further split into four groups; in total, 12 groups of adult mouse CMs in KB solution were maintained at 4° C. and allowed to settle to the bottom of Eppendorf tubes.

As the cell sorting device was being primed with a solution of HBSS with 30% FBS and 2.5 mM NaNO₂, one group of 4 Eppendorf tubes was prepared. The Eppendorf containing KB Solution and adult mouse CMs was left untouched. The other three Eppendorf tubes had the KB solution removed. In the second Eppendorf tube, HBSS with 30% FBS was added while in the third and fourth Eppendorf tubes, a solution of HBSS with 30% FBS and 2.5 mM NaNO₂ was added. The four Eppendorf tubes were then returned to 4° C. environment to allow the cells settle.

Once the cells had settled, 100 μL of CMs suspended in HBSS with 30% FBS and 2.5 mM of NaNO₂ were collected to run through the cell sorting device. The other three Eppendorf tubes containing adult mouse CMs in the three other solutions were left at room temperature while the device was running.

At the end of the sorting process, each of the Eppendorf tubes that had been sitting at room temperature were equally split into 24-well plate wells. The sorted run was emptied into one well. An equal volume of trypan blue was added to each well. After a minute, 1 mL of either KB or HBSS and 30% FBS was added to each of the wells depending on the group. Images were then taken for determining viability with dark blue cells being considered dead and light cells alive. This process was repeated for the other two groups of 4 Eppendorf tubes.

### Statistical Analysis

Statistical significance was determined using one-way ANOVA in conjunction with Tukey's test. Normality and equality of variance were tested. p<0.05 were considered significant. A minimum of 3 samples was used per data point.

### Results and Discussion

### Myoglobin Quantification and Paramagnetic Properties of Cells

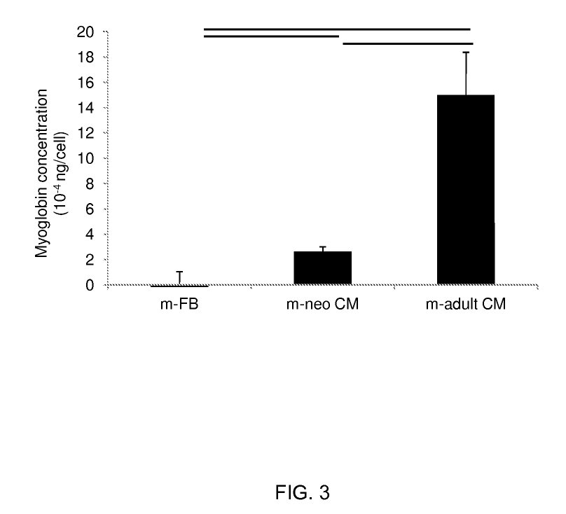

The amounts of myoglobin in the cells were confirmed by ELISA. Example results are shown in FIG. 3. FIG. 3 shows the amount of myoglobin per target cell (in this case, neonatal mouse CM (m-neo CM) and adult mouse CM (m-adult CM) compared to a negative control cell, fibroblast (FM). While non-contractile fibroblasts consistently tested below myoglobin detection levels for the ELISA kit, this protein was detected in both neonatal mouse CM, as well as in the adult CM with significantly higher concentration in the adult CM compared to the neonatal CM. Consistent with maturation of the cells, the amounts of myoglobin per cell increased more than 5 times in adult mouse CM compared to the neonatal mouse CM.

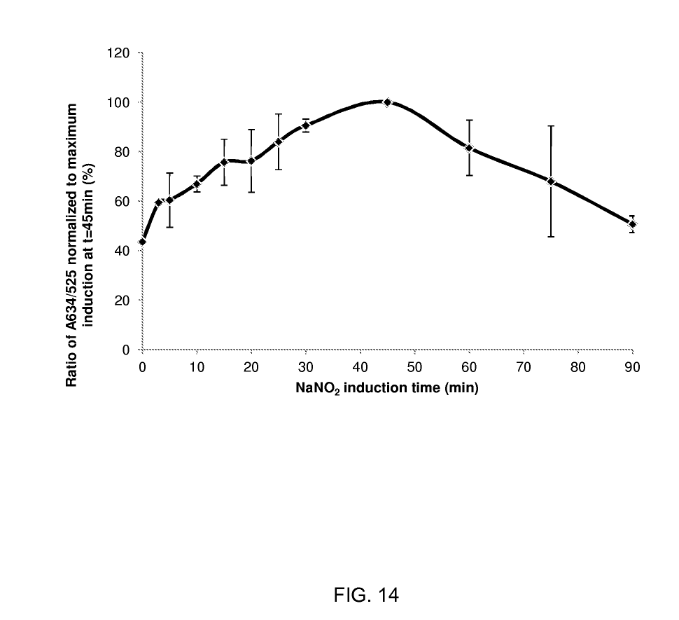

FIG. 14 shows further spectrophotometric measurements in adult mouse CMs treated with NaNO₂. FIG. 14 illustrates results analyzing the extent of induction of metmyoglobin from the total myoglobin upon treatment with 2.5 mM NaNO₂. Since myoglobin derivatives differ in their absorbance spectra, the ratio of the absorbance peak for metmyoglobin at 635 nm to the isobetic point for myoglobin, oxymyoglobin, and metmyoglobin at 525 nm contains information on the amount of metmyoglobin as a fraction of the total myoglobin [26]. It was observed that the maximum amount of myoglobin induction upon treatment with 2.5 mM NaNO₂ occurred at about 45 min after nitrite was introduced to the cells. Thus, it was expected that loading the cells into the column about 30 min after exposure should ensure CMs were rendered sufficiently paramagnetic during separation using the example device.

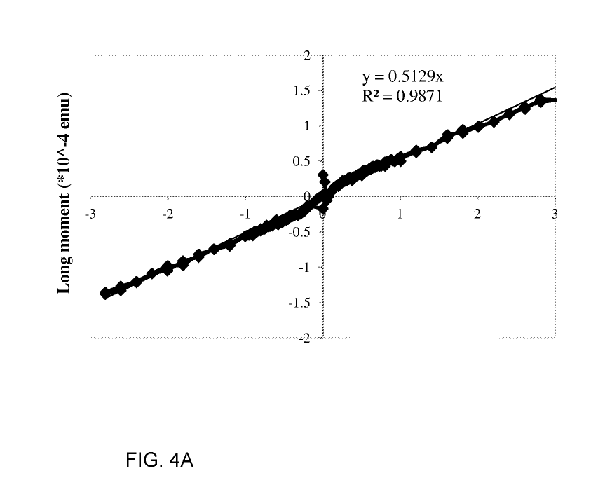

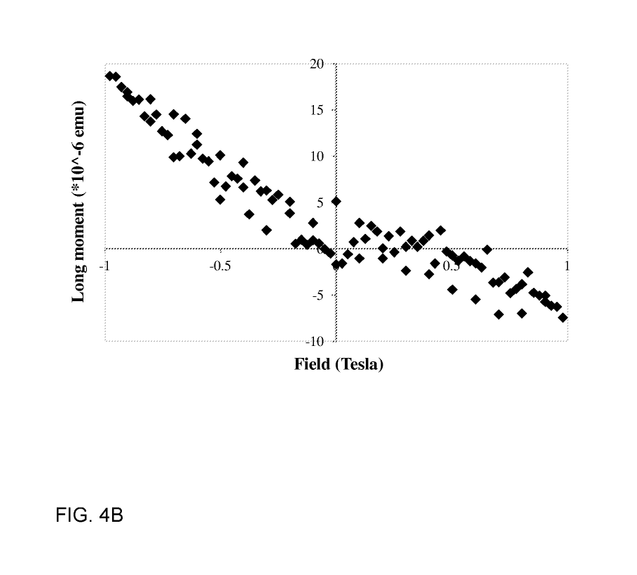

The disclosed example study has found that the non-magnetic CM could be rendered magnetic by treating the cells with 50 mM solution of NaNO₂ in PBS on ice. Magnetic susceptibility of the treated neonatal rat CMs was measured by superconducting quantum interference device (SQUID). FIGS. 4A and 4B show examples of magnetic property measurements of CMs and fibroblasts by SQUID. Magnetic field sweeps from −3 to 3 T of CMs (FIG. 4A) and fibroblasts (FIG. 4B) showed characteristic direct magnetization curves for paramagnetic (positive slope through zero) and diamagnetic (negative slope through zero) cells, respectively. Magnetic susceptibility of NaNO₂ induced metMb per CM is 1.58×10⁻⁵ at 1 Tesla and 25° C. (SI).

By studying how the magnetization of a sample changes with the strength of the magnetic field applied to the sample, the type of magnetization and the magnetic susceptibility may be determined. In this example, since temperature is constant throughout cell separation, magnetization was measured as a function of the applied magnetic field at a fixed temperature.

FIGS. 4A and 4B show example magnetic property measurements of CMs and fibroblasts through direct magnetization by superconducting quantum interference device (SQUID), using magnetic field sweeps from −3 to 3 T. Shown in FIG. 4A is a plot of M(H) for a typical paramagnetic CM sample at a fixed temperature. The linear curve intersects the axes at zero with a positive slope, characteristic of paramagnetic property. The magnetic susceptibility of NaNO₂-induced paramagnetic metmyoglobin (metMb) per CM was determined to be about 1.26×10⁻⁴ at 1 T and 25° C. (SI) for treated neonatal rat CMs.

Non-cardiac cells (fibroblasts) from myocardium were also measured as a negative control. In contrast to CM, the non-cardiac cells' M(H) plot (see FIG. 4B) was linear with a negative slope, described as diamagnetic. This demonstrated the distinct magnetic behavior of CMs versus the non-cardiac cells. According to Lenz's law, paramagnetic objects are expected to be attracted to higher magnetic field concentration, whereas diamagnetic objects are expected to be repelled.

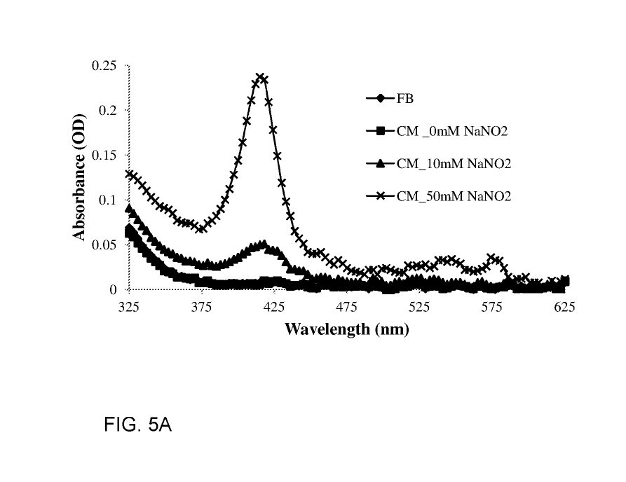

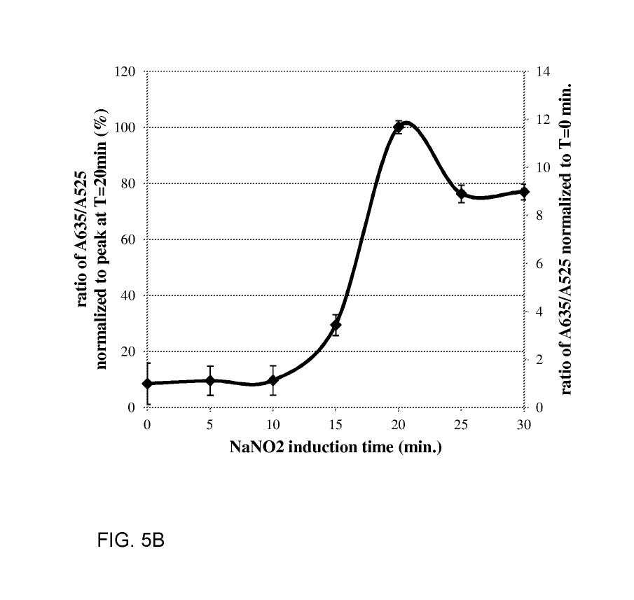

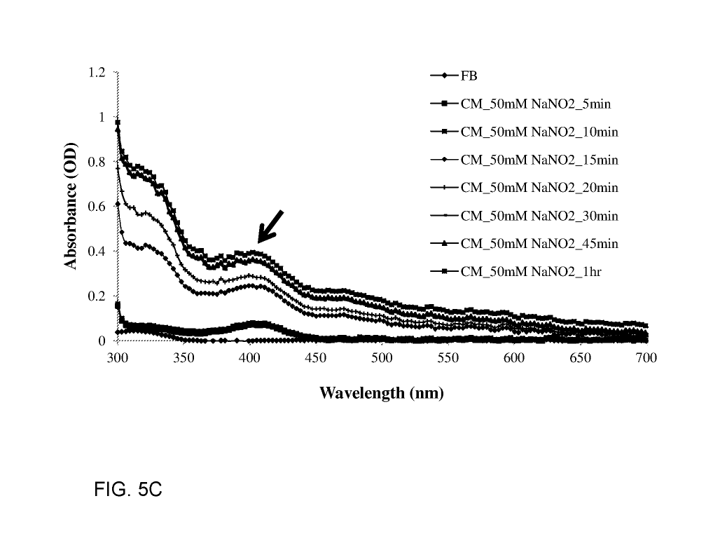

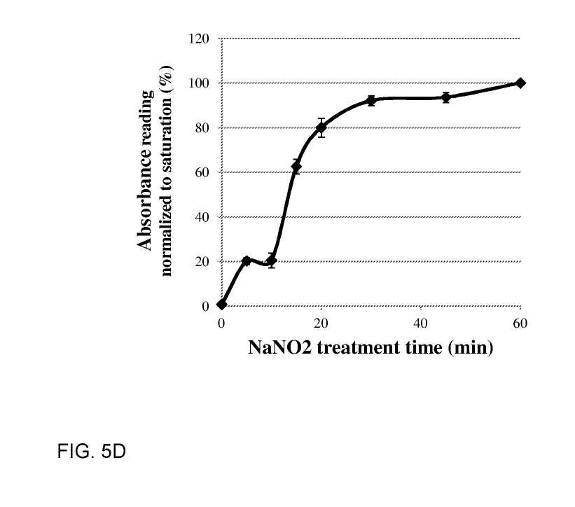

The presence of metmyoglobin (metMb) was also confirmed by spectrophotometric measurements in the samples treated with different concentrations (5-50 mM) of NaNO₂ for up to 30 min. FIGS. 5A-5C illustrate example spectrophotometery results showing metmyoglobin induction as a function of NaNO₂ concentration treatment condition in neonatal rat CM, with reference to the metMb soret band peak at about 409 nm. The dose response of metMb induction by NaNo₂ is shown in FIG. 5A as an absorbance spectra using UV/Vis spectrophotometer. The NaNO₂ concentration used ranged from about 0 to 50 mM for a treatment time of about 30 min. FIG. 5B shows results of a transient study of metMb induction under 50 mM NaNO₂, indicating increase of metMb peak with time of treatment. 30 min of 50 mM treatment was found to be sufficient to induce conversion of 92±3.5% Mb to metMb, referencing to the 1 hr time point. FIG. 5C shows transient metMb induction, shown by differential peaks (arrow).

In FIG. 5A, an increase in neonatal rat CM metMb soret band peaks was observed at 409 nm [25], as a function of increased NaNO₂ concentration treatment. With the presence of myoglobin derivatives in CM, the extent of induction of metMb from the total myoglobin was assessed. Since Mb derivatives differ in their absorbance spectra, the ratio of the absorbance peak for metMb at 635 nm to the isobetic point for Mb, oxyMb, and metMb at 525 nm contains information on the amount of metMb as a fraction of the total Mb [26].

In the transient study, as shown in FIG. 5C, the induction of metMb with time was observed, which reached the equilibrium value after 30 min. The semi-quantitative fold conversion to metMb stabilized to about 10 times the initial metMb amount (see FIG. 5B). The transient induction of metMb is shown again in FIG. 5C at the soret band. Despite some inevitable absorbance spill over from different Mb derivatives, the equilibrium saturation of metMb induction after 30 min of NaNO₂ treatment was repeatedly observed.

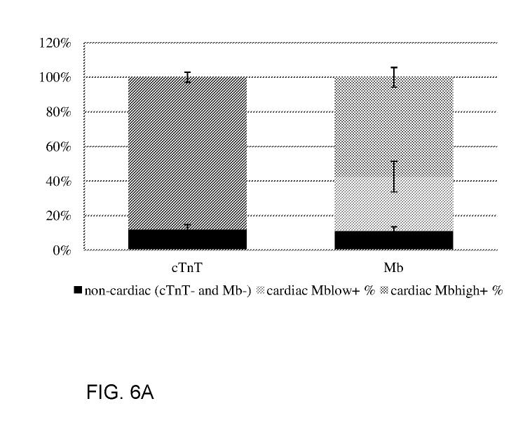

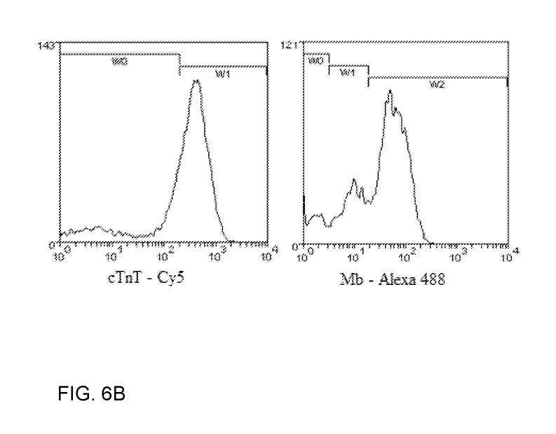

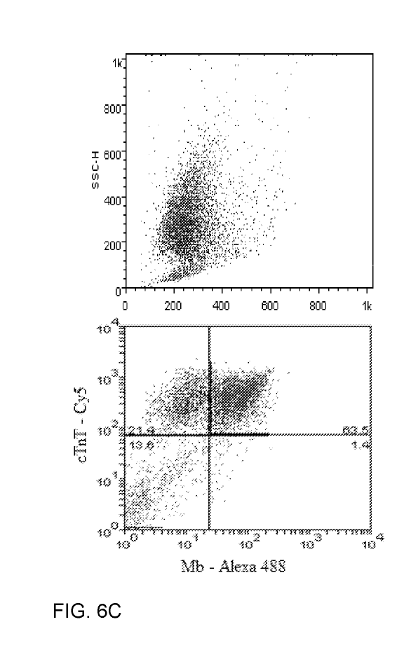

FIGS. 6A-6C show example results indicating that neonatal rat CM co-express cardiac Troponin T and Myoglobin. Freshly isolated cardiac cells were double stained for cardiac Troponin T (cTnT) and Myoglobin (Mb) and then subjected to flow cytometry. FIG. 6A shows average percentage of non-cardiac cells with negative cTnT and Mb staining and CMs with cTnT⁺ cells. cTnT+ cells separate into two subpopulations with distinctive amount of Mb, Mb^{high+} and Mb^{low+} (n=3). FIG. 6B shows representative flow cytometry plots of Cy5-cTnT FL4 and Alexa 488-Mb FL1. FIG. 6C shows forward and side scatter plots with color dots corresponding to the gating in the FL1/4 dot plot below.

The microfluidic separation technique disclosed herein may be useful for the separation of different sub-types of cardiomyocytes, e.g. ventricular vs. atrial cardiomyocytes. Using double staining for cardiac Troponin T and myoglobin, it was demonstrated that the CMs derived from neonatal rat heart cells co-expressed Troponin T and myoglobin.

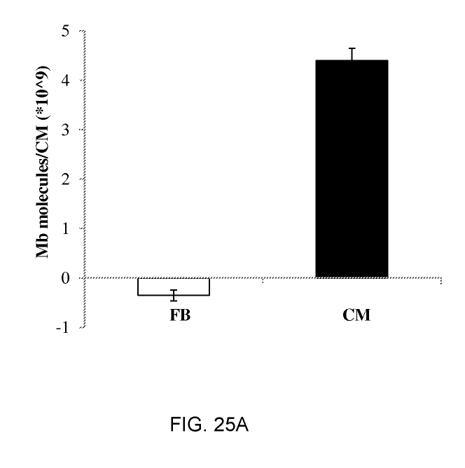

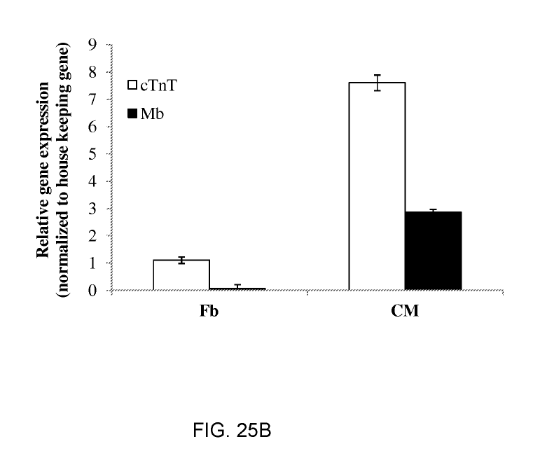

Myoglobin protein and gene expression was further confirmed in neonatal rat cardiomyocytes and quantified by qRT-PCR and ELISA, respectively. FIG. 25A shows example results from ELISA quantification of myoglobin per CM, where fibroblasts (FB) were used as a negative control. Here, neonatal rat CM was found to contain an average of 4.4×10⁹ Mb molecules/CM. FIG. 25B shows example results from qPCR of myoglobin gene expression in CM compared to FB. Here, the results show higher gene expression level compared to the fibroblast negative control.

In co-cTnT- and Mb-stained cells isolated from neonatal rat myocardium, two populations were observed: one that co-expressed Mb⁺/cTnT⁺ and one that was negative for both markers, Mb⁻/cTnT⁻ cells. Within the double-positive cells, two subpopulations were further observed: Mb^{high+} and Mb^{low+}. This finding is in agreement with literature reports concerning myogenesis, where a temporal-spatial expression pattern of myoglobin during postnatal development has been reported. After Mb mRNA level detected in early embryogenesis, Mb was found to be first expressed in the ventricles, and then in the atria, eventually leading to uniform expression in the adult heart [27]. The present example study with the neonatal rat resides in the developmental path, and the differential Mb expression may allow for opportunities of a dynamic separation protocol development to isolate cardiomyocytes of different sub-types and of different developmental states.

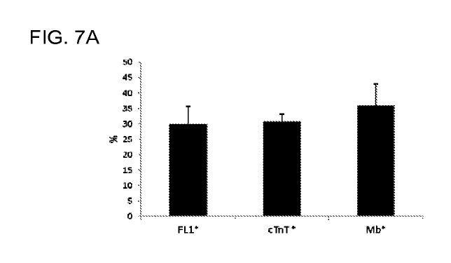

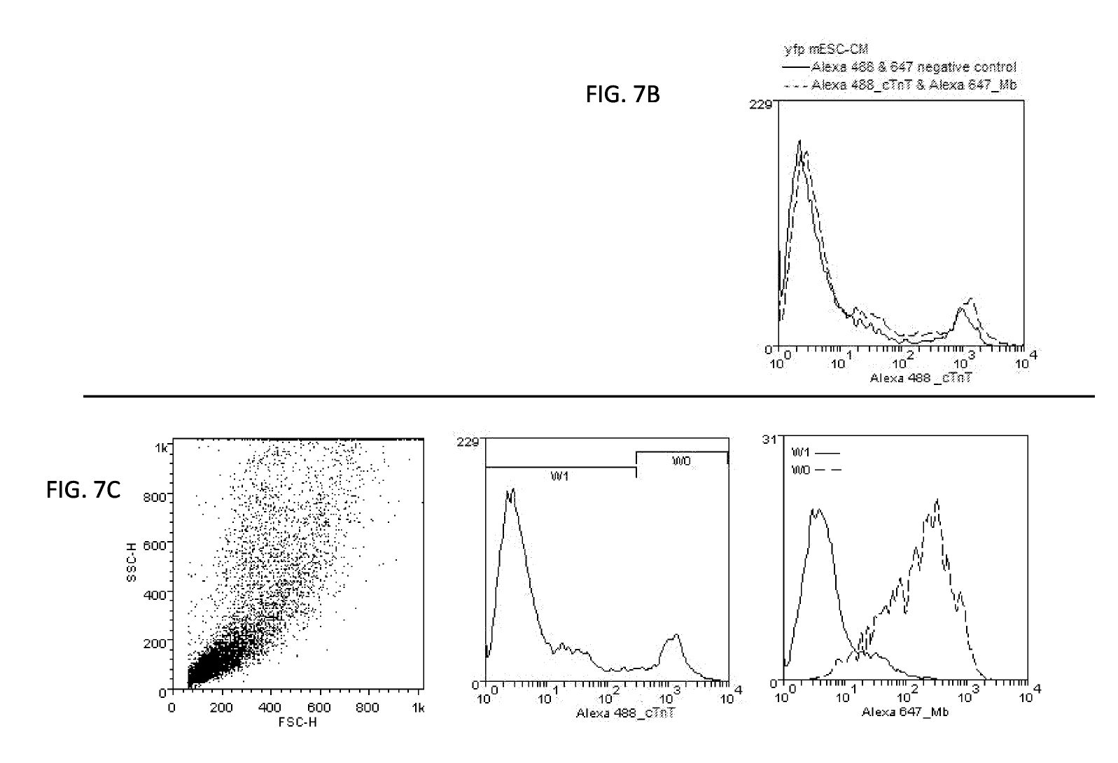

Similarly, upon EB differentiation of R1 mouse ESC, about 30% of cells were CMs as identified by troponin T staining and live YFP fluorescence. FIGS. 7A-7C show example results illustrating that mouse ESC-derived CM co-express cardiac Troponin T and Myoglobin. Mouse ESC G418-selecting line for myosin heavy chain (YC5-MHC-neo YFP) was serum-differentiated as embryoid bodies in bioreactors for 9 days before switching to selection media for another 9 days. The embryoid bodies were dissociated and the cells were double-stained for cardiac Troponin T and Myoglobin followed by flow cytometry.

Two distinctive populations were collected: YFP antibiotic-resistant live cells and non-fluorescent dead cells. FIG. 7A shows average percentage of FL1⁺ control cells with no immunostaining, cTnT⁺ cells and Mb⁺ cells (n=3). In FIG. 7B, the YFP+ cells are CMs as demonstrated by the overlay of the control cells with no immunostaining to the sample stained for Alexa 488-cTnT. FIG. 7C shows the FL1⁺ cells co-localized with Mb⁺ indicated CM cells expressing Mb. Representative flow cytometry plots are also provided in FIG. 7C.

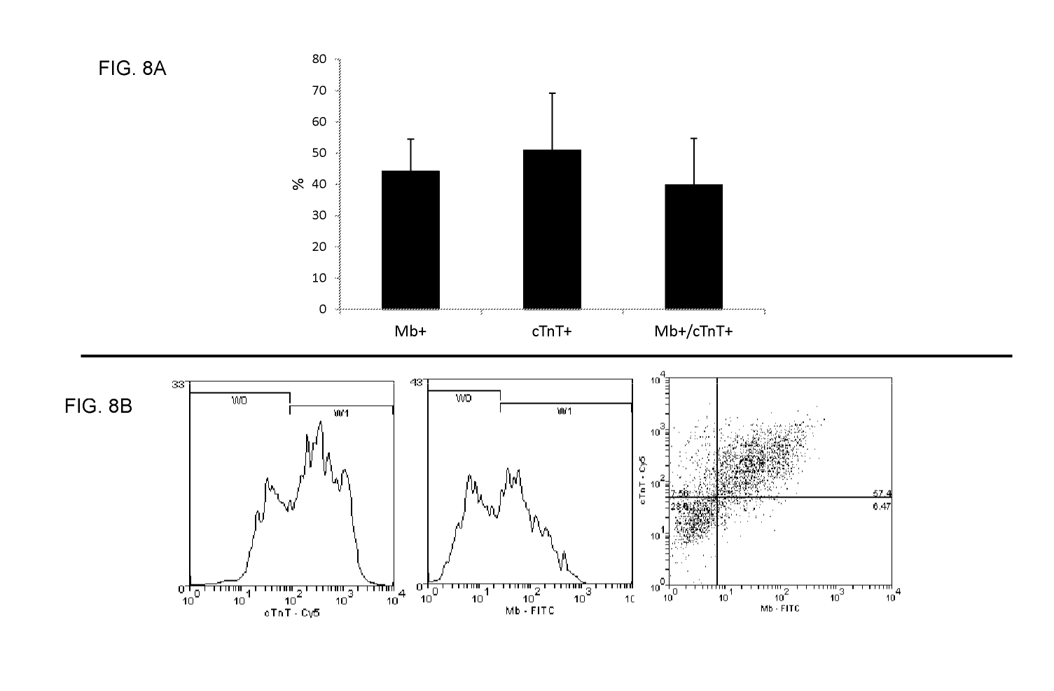

All of these cells were also positive for myoglobin. Measurements with hESC-derived CM demonstrate the presence of myoglobin in these cells at Day 20 of embryoid body differentiation (see FIGS. 8A-B) similar to the expression of myoglobin in neonatal rat CM and mouse ESC derived CM (see FIGS. 6A-C and 7A-C).

FIGS. 8A and 8B show example results illustrating that human ESC-derived CM co-express cardiac Troponin T and Myoglobin. Human ESCs (Hes2 line) were differentiated as embryoid bodies using cytokine induction for 20 days. The embryoid bodies were dissociated and the cells were double-stained for cardiac Troponin T and Myoglobin followed by flow cytometry analysis. FIG. 8A shows average percentage of Myoglobin+ cells, cardiac Troponin T+ cells and double positive cells showed most hESC derived CM express Myoglobin (n=3). FIG. 8B shows representative flow cytometry plots.

### Viability and Functionality of Cells Upon NaNO₂ Treatment

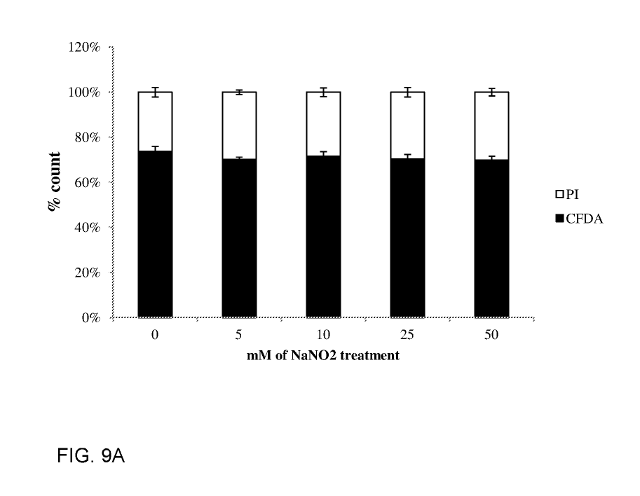

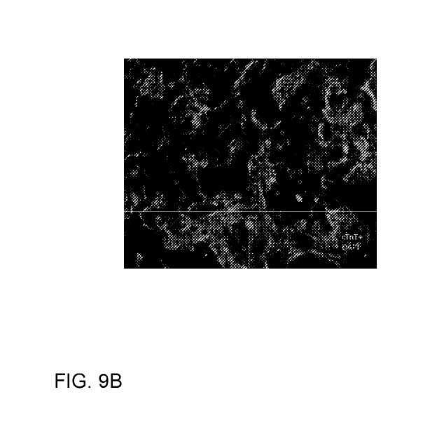

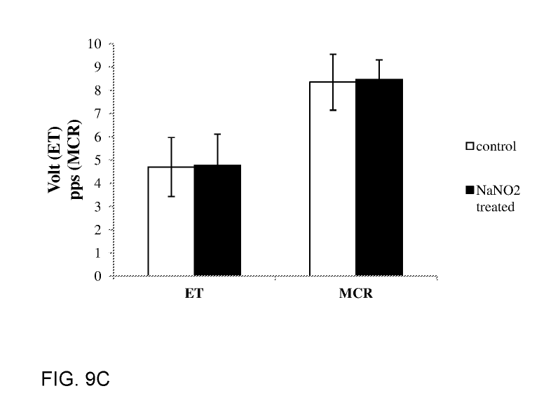

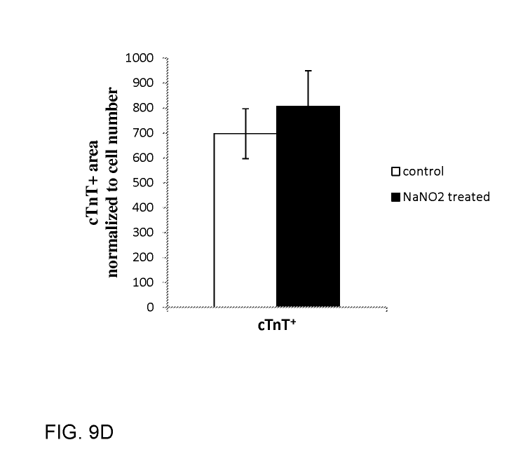

The example study also carried out investigations to verify that NaNO₂ treatment did not compromise cell viability or their functionality. FIGS. 9A-9D show example results illustrating that the viability of cells is preserved after NaNO₂ treatment and cell separation.

FIG. 9A shows dose response of NaNO₂ on viability of neonatal rat CM. No significant difference was found in the CFDA positivity of neonatal rat CM following up to 50 mM NaNO₂ treatment, indicating the cells remained viable in the tested range. The cells were treated with the indicated concentration of NaNO₂ for 30 min on ice. FIG. 9B shows that NaNO₂ treated cells can generate a cardiac patch upon seeding into porous collagen scaffolds. Immunostaining for cardiac troponin T appears as green, as indicated by various arrows. Furthermore, to examine whether cell functionality was affected by the NaNO₂ treatment, treated cells were cultured in 3D scaffold and functional testing conducted through electrical stimulation. As shown in FIG. 9C, the constructs based on the treated and control cells show no significant differences in functional properties, excitation threshold (ET was about 4.5±1.3V/cm) and maximum capture rate (MCR was about 8.3±1.0 pps). FIG. 9D shows that the treated and control cells exhibit similar levels of staining for a cardiac marker (in this case cardiac troponin T, a regulatory protein integral to muscle contraction).

### Microfluidic Enrichment Results

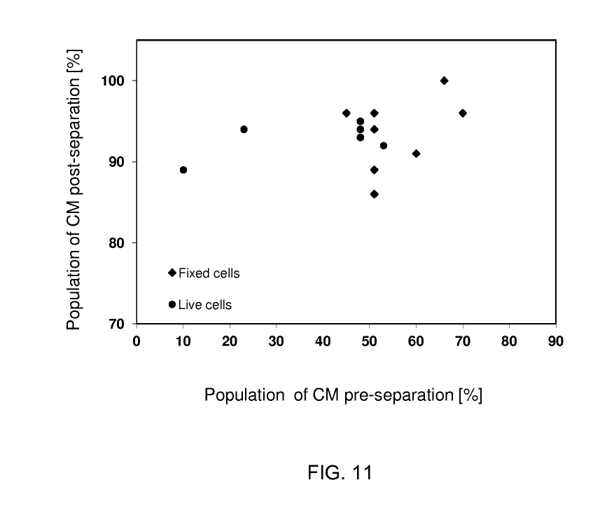

Cell separation experiments with paraformaldehyde-fixed adult CM in the example device described with respect to FIGS. 1A-C and 2A-C showed that the highest enrichment was achieved at a flow rate of about 4.2 μL/min, consistent with the simulation analysis above. The average enrichment in a single pass for the fixed cell population was 93±4% (N=8), thus about 4.2 μL/min was selected to obtain the results shown in FIG. 11 (described further below) The initial cell concentration was consistently maintained at about 0.2 million/ml, as higher concentrations tested (up to about 5 million/ml) resulted in lower enrichment, possibly due to overcrowding and/or formation of heterogeneous cell clumps, consisting of both CM and FB, that may have hindered the separation process.

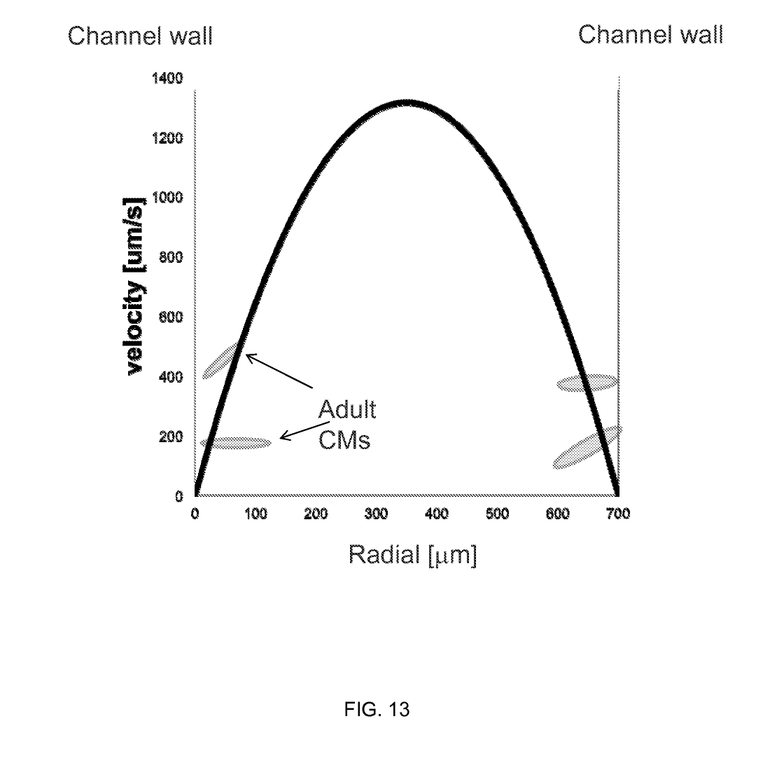

FIG. 13 shows the theoretical parabolic velocity profile for a fully developed laminar flow at the rate of about 4.2 μL/min within a 700 μm diameter settling chamber. This velocity profile may be described using equation (13) below:

$$V = \frac{2 Q}{A} ( 1 - {( \frac{r}{R} )}^{2} ) \qquad ( 13 )$$

where V is the velocity of flow along the channel at distance r from the center of the settling column, R is the radius of the column, Q is the flow rate and A is the cross sectional area of the settling column.

The results of this calculation, as plotted in FIG. 13, indicate that within a half-cell-length (e.g., about 50 μm) distance from the wall of the settling chamber, the flow travels slower than about 250 μm/s. In the example configuration described, the velocity entrance length Lv (i.e., the length from the flow inlet to when laminar flow is developed) may be calculated as follows [37]:

Lv=Rc(1.18+0.112Re) (14)

where Rc is radius and Re is the Reynolds number, Re=0.176 assuming dynamic viscosity of the media is about 0.001 NS/m². Based on equation (14), the velocity entrance length Lv in the example configuration described is about 0.42 mm. This shows that over substantially all of the column length (in this example about 15 mm), the flow is laminar and fully developed. This calculation verifies that the equation for a laminar, fully developed velocity profile may be used to model flow in the settling column.

A transient or turbulent flow over a significant or majority portion of the length of the settling column may hinder the separation of target material, since such flow typically would move the target material away from the inner wall of the settling column and cause the target material to be mixed with the non-target material, despite the applied magnetic field. By appropriately controlling the viscosity of the media and/or the flow rate, the flow may be controlled to be laminar through most or substantially all of the length of the settling column.

The terminal velocity of adult CM is greater than the settling velocity of fibroblasts given above due to the larger length of the adult CM may be as high as about 100-150 μm. This settling velocity of adult CM was measured in this study to be between about 100-150 μm/s for cells that were suspended in culture media and were far from the column wall. In preliminary experiments, it was observed that at too-low flow rates, the non-magnetic FBs stayed in the column and at too-high flow rates, all cells were rinsed out. Therefore a series of experiments were conducted to determine the appropriate flow rate. As described above, the appropriate flow rate was determined to be about 4.1-4.2 μL/min for a 700 μm diameter settling chamber, in order to obtain the highest enrichment of CM. This was selected to be the flow rate for all tests in this example study.

FIGS. 15A-15C show further simulation and calculation results. These figures show example results of mathematical modeling of hydrodynamic and magnetic force effects on a paramagnetic particle trajectory in a vertical settling column. The velocity entrance length was calculated for the 700 μm diameter column at 4.2 μL/min.

FIG. 15A shows a simulated velocity profile of the fluid flow at 4.2 μL/min within the 700 μm diameter column. FIG. 15B illustrates the balance of magnetic and gravitational forces acting on a paramagnetic particle in the vertical column, as a function of radial position in the column.

In a batch separation approach, the heterogeneous cell population would be first loaded into the settling column of the example device. Once in the settling column, the paramagnetic CM would be attracted towards the column wall as a result of the magnetic field gradient generated by the nickel wire and the presence of the permanent magnet. The calculations and simulations described above showed that the flow rate from the bottom of the column could be adjusted in such a way to keep the CM in the device and rinse out the non-paramagnetic fibroblasts.

At the given settling column radius and the magnitude of the magnetic field, the percentage of CM trapped in the device is expected to depend on the applied flow rate and the length of the settling column. In the analysis described here, it was assumed that the paramagnetic cell was initially present at the centerline at the bottom of the column. The trajectory of such a paramagnetic cell inside the column was calculated at different flow rates. Based on such calculations, it was expected that the paramagnetic cell would travel upward in the column and towards the wall where the nickel wire was circumferentially positioned (and thus where the magnetic field was strongest), reaching the wall of the column after a certain distance was traveled in the z-direction. Due to the no slip boundary condition at the column wall it was assumed that cells would be trapped inside the column once they reached the wall. FIG. 15C illustrates simulated trajectories of a paramagnetic particle initially placed in the center at the bottom of the column, as a function of fluid flow rate (in this example, 4.2, 9.5 or 10 μL/min). A column length of 15 mm was assumed.

The size of the adult CM was determined by image analysis. These cells were rod/elliptical shaped with the average long axis of 77±14 μm and the short axis of 25±3 μm (N=10). The area of each cell was calculated using the area of the ellipse formula, based on the measured long and short axis. For each calculated area, a radius of the circle occupying the same area was calculated. This radius was termed effective cell radius. For the purpose of mathematical modeling, the effective cell radius determined as described above was set to be 22 μm.

The ratio of magnetic force to the gravitational force applied on a representative sodium nitrite-treated paramagnetic CM that is at the same level as the nickel wire (that is, θ=0) is plotted in FIG. 15B, as a function of radial position in the column, by substituting values from Table 1 in the equations above. The theoretical analysis shows that at the central areas of the column (that is, farther than 100 μm from the column wall) the magnetic force is smaller than the gravitational force, likely due to the low magnetic susceptibility of the CM. These results indicate that the resulting velocity of the cells toward the magnet is smaller than the cell's typical settling velocity which is calculated to be 64.4 μm/s for a cell with effective radius of 22 μm [28]. Therefore, the flow rate in the column should be set to be slow to prevent the washout of the desired cell type.

Examples of calculated cell trajectories are shown in FIG. 15C. Based on the calculations, it was found that at 4.2 μL/min, the CM cell is expected to fall on the column wall after 1.475 mm, and percentage of trapped cells is expected to be 100% for a column which was 15 mm long and dimensioned as described in Table 1. At 35 μL/min, the CM cell is expected to fall on the column wall after 14.817 mm and percentage of trapped cells is expected to be 100%. At 36 μL/min, the CM cell is expected to leave the column and the percentage of trapped cells is expected to be 75%.

To confirm the enabling contribution of the magnetic effects and rule out the possibility that the enriched population was only due to the difference in size, density, or the difference in settling velocities alone of the adult mouse CM and neonatal fibroblasts, several tests were conducted in the absence of the magnet. For these control tests, similar to the tests with magnet, mixtures of live or fixed CM with fibroblasts were treated with NaNO₂. The same media and flow rate was used for the control tests to ensure that the viscosity of the fluid was the same. In the absence of a magnet, most of the cells were rinsed out of the column, as expected.

Separation tests with live cells at the flow rate of 4.2 μL/min were also performed. Live adult mouse CMs were mixed with live pre-plated neonatal fibroblasts at different ratios. The enrichment efficiency of the live cells averaged at 93±2%. No significant difference was observed between the results of fixed and live cells (see FIG. 11). As shown in FIG. 11, application of a magnetic field during the separation process resulted in consistently high and efficient enrichment of about 90-100%.

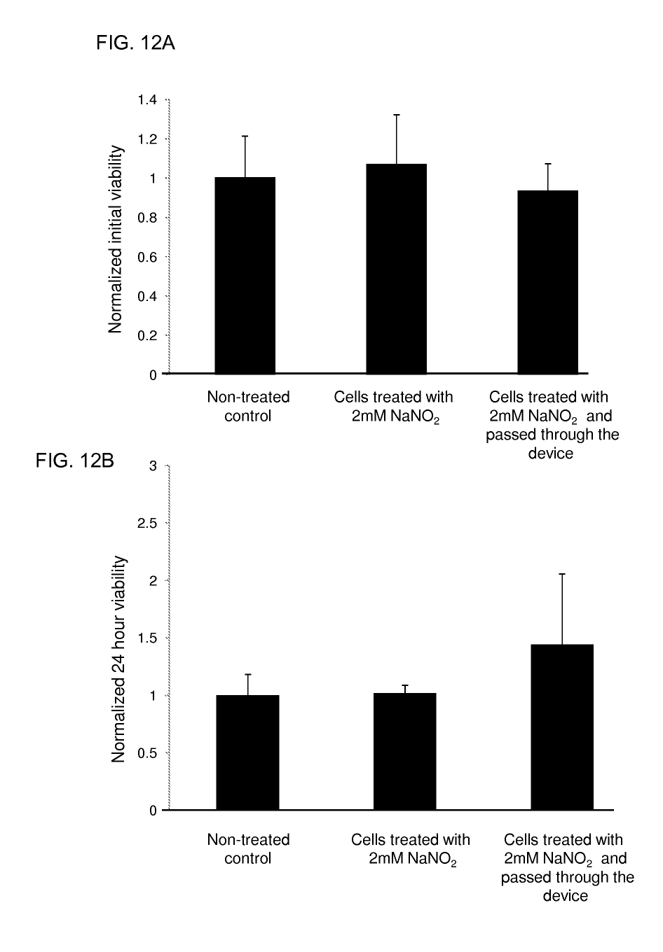

Viability of adult mouse CM after separation and subsequent culture for 24 hr was found to be not compromised by the treatment with NaNO₂ or passage through the device. FIGS. 12A and 12B show the viability of adult mouse CMs after separation (FIG. 12A) and after subsequent culture for 24 hours (FIG. 12B). In both cases cell viability was comparable to that of the control cell population that was not treated with NaNO₂ and not separated. The treatment of cells by NaNO₂ is thus not expected to decrease cell viability. In fact protective effects of NaNO₂ on myocardium have been found [38, 39].

### Conclusions

CMs may be rendered transiently paramagnetic by application of NaNO₂ treatment. The separation was found to not compromise cell viability. This method enables label-free enrichment of live CMs. The results of this example study indicate the feasibility of a clinically viable label-free CM purification approach. The ability to exploit the native inducible paramagnetic properties of CM to be utilized for separation further offers clinically relevant highly enriched CMs.

### Other Examples

Examples are now described where the separation of target cells may take place in a horizontal chamber, rather than in a vertical settling column.

This example embodiment may be referred to as a high gradient magnetic sorting (HGMS) system. Similar to the examples described above, this example may make use of the presence and paramagnetic inducible myoglobin in CMs for CM separation.

An example HGMS system was developed and investigated for CM rendered paramagnetic by oxidation of ferrous myoglobin (Mb) to ferric metmyoglobin. This example system was investigated for its ability to capture small particles with low magnetic properties from fluids. System operational parameters may be controlled to mobilize paramagnetic particles. The magnetic gradient may create a spatial differential alignment of the paramagnetic unpaired spins within a paramagnetic entity (e.g., the target particle, in this case CM), resulting in a force driving the entity in the direction of the increasing magnetic field.

The example system described here may employ HGMS for separation of CMs (which may be rendered paramagnetic through sodium nitrite treatment), using an axial configuration design.

### Example of Axial Configuration

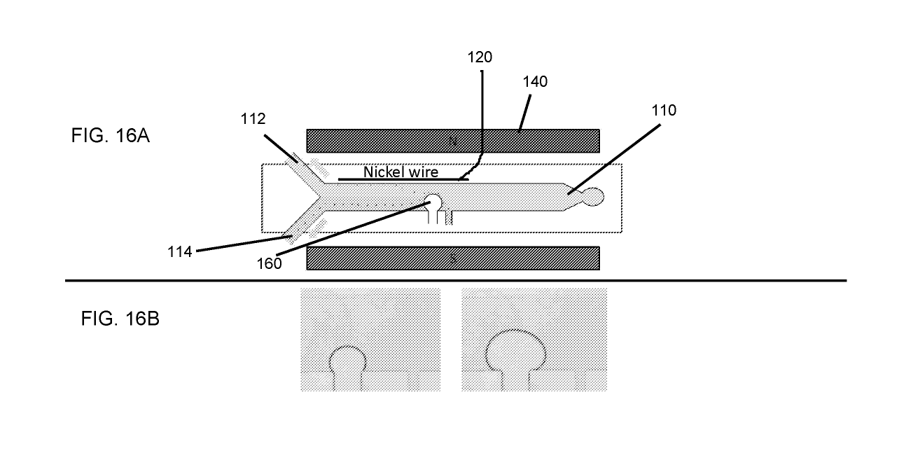

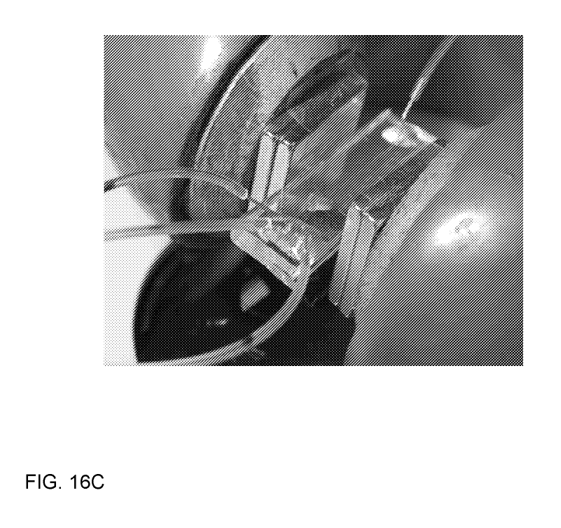

FIG. 16A shows an example design in which the settling chamber is arranged horizontally, resulting in a flow-through configuration. In this example, the device included a horizontal fluid channel 110 in which media containing target and non-target material may be introduced through an inlet. The fluid channel 110 may split into a target material outflow channel 112 and a non-target material outflow channel 114. An asymmetric magnetic field may be applied (e.g., using a metal wire 120, such as a nickel wire, and a set of permanent magnets 140) to attract target material towards the target material outflow channel 112, while non-target material settle towards the non-target material outflow channel 114.

In some examples, attraction of the target material towards the target material outflow channel 112 (i.e., towards the metal wire 120) may be assisted by introducing a bubble, such as a mineral oil droplet 160, to divert the media flow in the fluid channel 110. The diameter of the oil droplet 160 may be adjusted, as shown in FIG. 16B (e.g., through control of the size of the opening through which the droplet 160 is introduced), to enable control of input position of the target material with respect to the wire 120. The incorporation of the oil droplet 160 may enable tuning of the input material distance during the separation process to help enable more efficient separation.

A buffer sheath (not shown) may be incorporated inside the fluid channel 110 on the side closer to the wire 120, to allow only the paramagnetic target material to be collected as the enriched stream in the target material outflow channel 112.

FIG. 16C shows an image of an example device, according to the configuration described above. A neodymium iron boron (Nd—Fe—B) horseshoe permanent magnet generated the external magnetic flux measured using a Gauss/Tesla-meter. To obtain high magnetic flux, additional magnets were attached to the horseshoe. The assembly achieved 0.6 T and was applied perpendicular to the wire axis.

While designing the example device for CM separation in axial configuration, the physical and operational parameters such as channel length requirement and flow rate optimization, respectively, were examined through calculations and simulations.

The models derived from Birss's work, where analytical solutions were established from linearized paramagnetic particle motion in radial and azimuthal directions were applied in simulations, as discussed below [70]. The effect of particle entrance point relative to the ferromagnetic element on the minimum wire length required for magnetic particle projection to the channel wall containing the nickel wire was also investigated. To predict how the ferromagnetic nickel wire placed axially along the channel length will act as a concentrator to generate high magnetic field gradients in its surrounding, simulations were carried out using a simplified one-dimensional magnetostatic model by commercial software (COMSOL multiphysics).

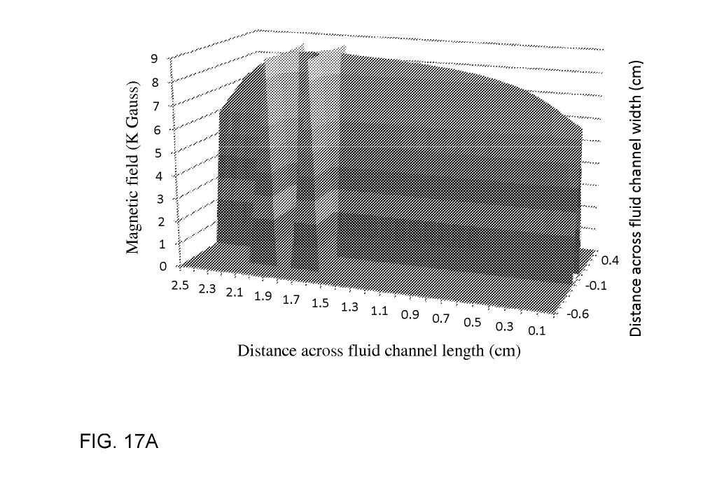

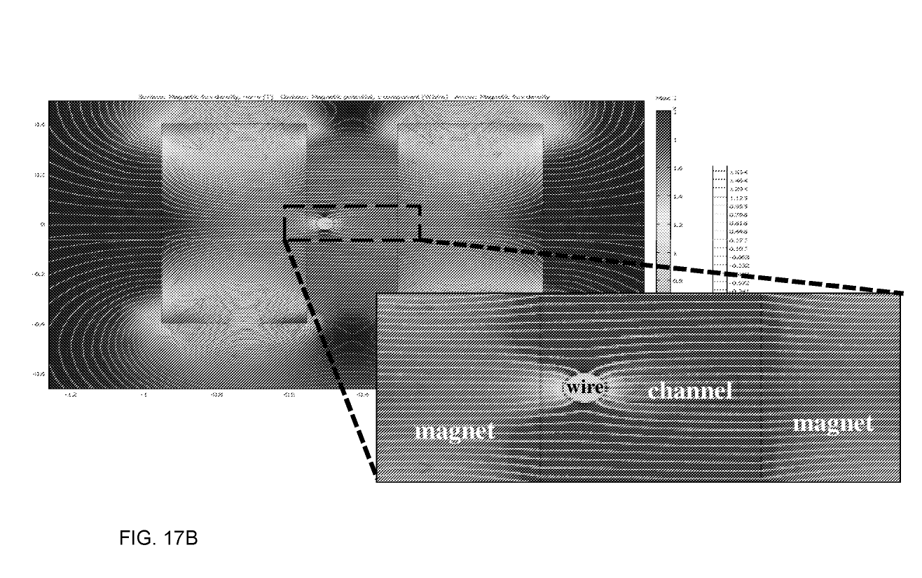

FIG. 17A shows the simulated magnetic field strength across the device. These simulation results indicate that the magnetic field strength reaches about 0.8 T and remains substantially constant through the width of the fluid channel. FIG. 17B shows an example of COMSOL simulation of magnetic flux density distribution around a magnetized ferromagnetic nickel wire (B₀=0.8 T).

The separation device design was supported by theoretical analysis, as discussed below. Paramagnetic CM motion was simulated with a theoretical model applying measured biological and fabricated technical specifications, and was used as a reference for design of nickel wire length subject to a homogeneous magnetic field.

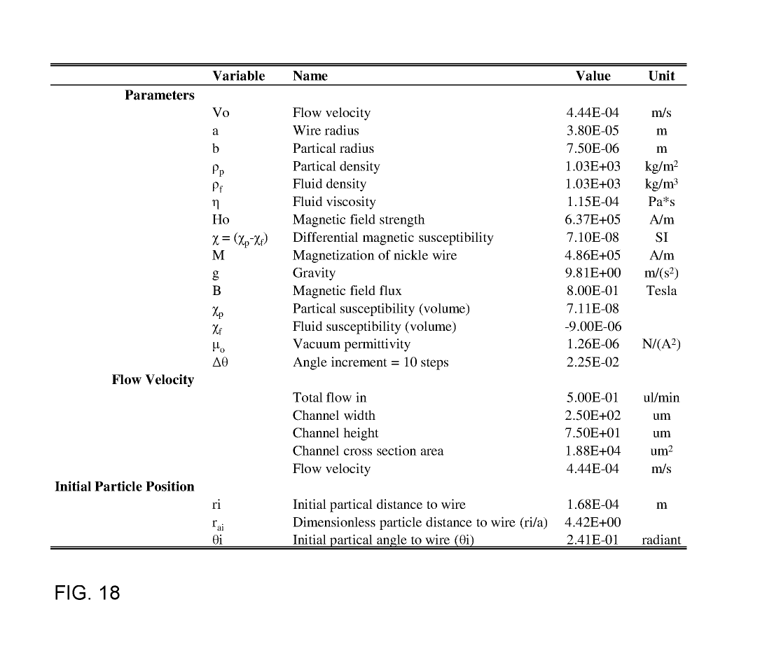

Paramagnetic particle motion in the example device is governed by: magnetic force, Fₘ (see equations 15a and 15b), viscous drag force, Fᵥ (see equations 16a and 16b), and gravitational force, F_{g} (see equations 17a and 17b), shown in cylindrical coordinates. The derived analytical solution to the equations of motion for a paramagnetic particle in the axial configuration of HGMS was solved by Birss, et al. in cylindrical coordinate system (see equations 18 and 19). After specifying the initial particle position (rₐₜ,θₜ,Zₐ), subsequent particle motion may be simulated. Example simulation parameters are listed in the table shown in FIG. 18.

$$\begin{matrix} {F}_{mr} = - \frac{4 {πμ}_{0} χ {Ma}^{2} {b}^{3}}{3 {r}^{3}} [ \frac{Ma}{2 {r}^{2}} + {H}_{0} cos 2 θ ] & ( 15 a ) \\ {F}_{m θ} = - \frac{4 {πμ}_{0} χ {Ma}^{2} {b}^{3}}{3 {r}^{3}} {H}_{0} sin 2 θ & ( 15 b ) \\ {F}_{vr} = - 6 πη b [ \frac{d r}{d t} - {V}_{r} ] & ( 16 a ) \\ {F}_{v θ} = - 6 πη b [ r \frac{d θ}{d t} - {V}_{θ} ] & ( 16 b ) \\ {F}_{gr} = \frac{4 π {b}^{3}}{3} ( {ρ}_{p} - {ρ}_{f} ) g cos ( θ - β ) & ( 17 a ) \\ {F}_{g θ} = - \frac{4 π {b}^{3}}{3} ( {ρ}_{p} - {ρ}_{f} ) g sin ( θ - β ) & ( 17 b ) \\ {r}_{a} = {( - K cos 2 θ + C \vert sin 2 θ \vert )}^{\frac{1}{2}} & ( 18 ) \\ {Z}_{a} = ( \frac{{V}_{0 a}}{{V}_{ma}} ) [ \frac{1}{2} {K}^{2} ln ( \vert \frac{tan {θ}_{t}}{tan θ} \vert ) ] - K ( {r}_{at}^{2} - {r}_{a}^{2} ) - \frac{1}{2} ( {K}^{2} + {C}^{2} ) ( cos 2 {θ}_{t} - cos 2 θ ) & ( 19 )\end{matrix}$$

Magnetic flux density distribution was generated using COMSOL around a magnetized ferromagnetic nickel wire (B₀=0.6 T). Briefly, 2D cross-sectional view in the direction of magnetic field flux was drawn. Then, boundary conditions were specified based on measured magnetic strength of the permanent magnet. A mesh was generated and solved with the built-in algorithm. Convergence was reached at 10⁻⁷ and colors shown to represent high field strength.

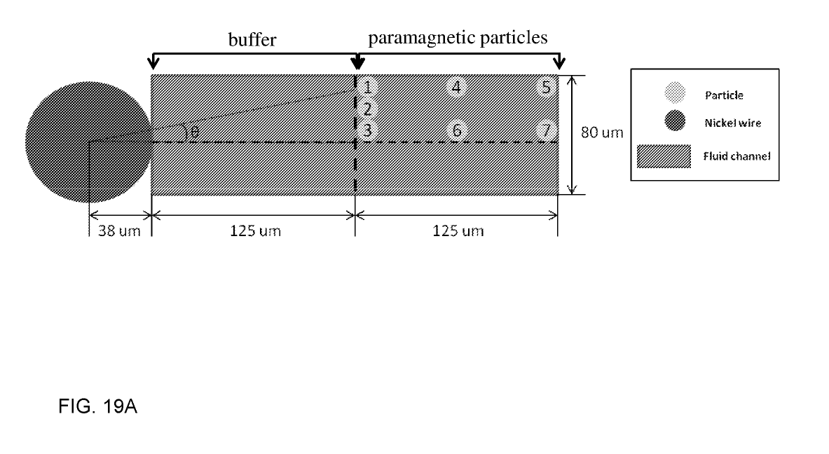

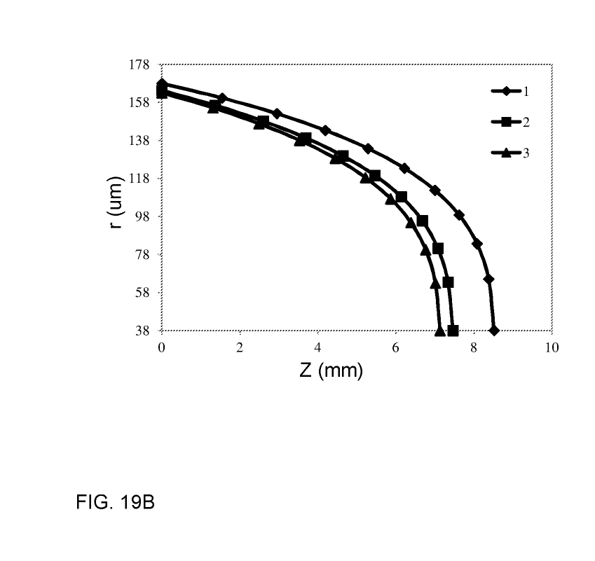

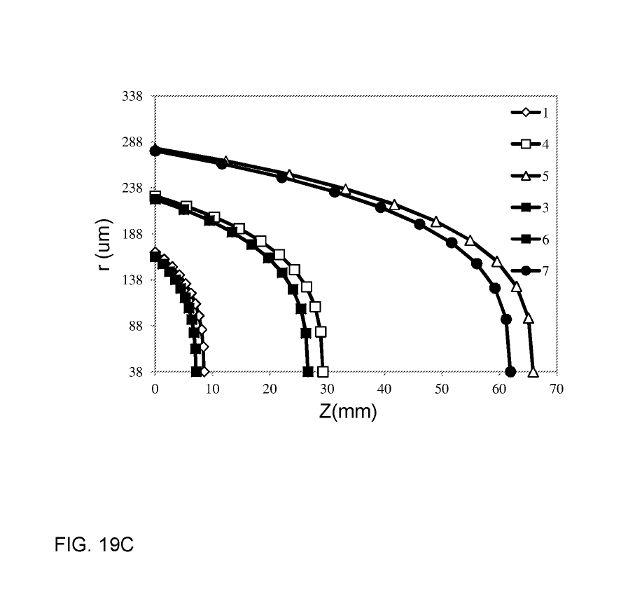

FIGS. 19A-C illustrate representative particle entrance positions in the fluid channel and the resulting simulated particle trajectory.

FIG. 19A shows the schematic of a circular wire on the left of a rectangular flow channel, within which different particle entrance points are numbered 1 to 7. The particles shown enter the fluid stream on the side of the channel opposite to where the wire is positioned, and spaced by a buffer stream. The magnetic force experience on the particle (CM in the example simulations) is dependent on its height in the channel and distance from wire within the channel.

FIG. 19B compares the trajectories of particles entering the channel at different channel height positions (y=40, 20, and 0 μm; particle 1, 2, and 3, respectively). FIG. 19C compares the trajectories of particles entering the channel at different length distances from the wire center (x=163, 225.5, and 288 μm, particle (1,3), (4,6), and (5,7), respectively). In FIGS. 19B and 19C, r is the distance from the particle to the wire, and z is the channel length. These figures indicate that the length distance from the particle to the wire has a greater influence than the height position of the particle.

As illustrated by FIG. 19B, for particles entering at different y-axis positions, those at the top of the fluid channel required longer distance to be attracted to the wire compared to particles closer to the center of the channel height. As illustrated by FIG. 19C, for particles entering at different x-axis positions, those farther from the nickel wire (i.e., the magnetic field concentrator) required longer distance to be attracted to the wire compared to particles entering closer to the wire. The results of these simulations indicate that the more aligned the particle in parallel to the wire radial center and the closer the particle to the wire, the stronger the magnetic attraction force, and hence the shorter the distance (and hence wire length) required. As such, the introduction of an oil droplet may be useful to better position the particles as they entering the channel.

### Microfluidic Device Fabrication and CM Separation

An example method for fabrication of a horizontally configured HGMS device is described below. Other fabrication methods and/or variations on this example method may be suitable.

A microfluidic device master was fabricated via standard soft lithography techniques. In brief, a silicon wafer was coated with SU-8 25 (from MicroChem Corp., Newton, Mass.) photoresist with a spin coater and exposed full to create a seed layer. A mask drawn on AutoCAD softward and printed with 2000 DPI resolution (CADART) was placed on top of a feature layer of SU-8 2050, with exposure energy specified on MicroChem manual by UV light (Q2001, from Quintel Co., San Jose, Calif.). The unexposed photoresist was then removed using SU-8 developer propylene glycol monomethyl ether acetate (from MicroChem). Nickel wire was fixed straight on a flat piece of cured silicon elastomer poly(dimethylsiloxane) (PDMS) with curing agent (at a ratio of 10:1). With the nickel wire placed adjacent in parallel to the channel, more PDMS was molded on the SU-8 masters at 80° C. for 1 hr. Inlet and outlet were punched with 22-gauge needles, then plasma treated to be bonded to another flat PDMS. Tygon tubings (from Thomas Scientific) were press fitted into the holes. Mineral oil (from Sigma) was used to create the droplet in the channel.

Hydrophilicity of the fluid channel was of concern for the creation of the contact angle required for the oil droplet. Hence, the droplet was created within about 15 min after the device was assembled through plasma treatment of PDMS surface bonding. Throughout the three consecutive batches of separations of one hour each tested in this study, the oil droplet maintained its circular shape. A syringe pump (Harvard PHD Ultra CP) was used to drive the flow. Cells were placed in a 1 mL syringe and injected to cell inlet by the syringe pump at 0.5 uL/min.

### CM Separation Throughput, Viability, and Functionality Study

CM Throughput.

Cell collected from each outlet were resuspended in PBS to a final known volume, counted with a hemacytometer, then back-tracked total cell number through multiplication of total suspension volume. The fraction of total input cells collected by each outlet was then determined.

Cell Viability.

Live/dead staining was performed by incubating the cells or constructs in a solution of carboxyfluorescein diacetate-succinimidyl ester (CFDA-SE, 10 μM, from Molecular Probes) and propidium iodide (PI, 2.5 μg/mL, from Molecular Probes) for 30-45 minutes at 37° C., according to the manufacturer's protocol (from Molecular Probes, Burlington, Canada). The cells were imaged using a fluorescent microscope (Leica DMIRE2, from Wetzlar, Germany). The live/dead staining was performed for CMs subjected to NaNO₂ concentrations of 5, 10, 25, or 50 mM, dissolved in HBSS and for a negative control (HBSS without NaNO₂) at 4° C. for 2.5 hrs. Upon treatment, the cells were washed in HBSS, and incubated for 5 hrs in 37° C., 5% CO₂ incubator. Non-viable cells with compromised cell membranes could be identified by red fluorescence due to binding of PI to their nuclei, while viable cells converted CFDA-SE to the green fluorescent dye CFDA by esterase-mediated cleavage.

Electrical Function Evaluation.

Construct was prepared by seeding neonatal rat myocytes (6×10⁶ cells) onto Ultrafoam collagen sponges (6×8×1.5 mm) using Matrigel® (from Becton Dickinson). Constructs were cultured for 4 days in a 37° C. and 5% CO₂ humidified incubator to allow the cells to attach to scaffolds and to recover from isolation. After culture, constructs were transferred to a chamber fitted with two carbon rods (from Ladd Research Industries, Burlington, Vt.) placed 1 cm apart and connected to a cardiac stimulator (from Nihon Kohden, Tokyo) with platinum wires (from Ladd Research Industries). CMs were paced using square pulses 2 ms in duration. The stimulating voltage was varied to determine excitation threshold (minimum voltage necessary to induce synchronous contractions) and maximum capture rate (maximum beating frequency at two times the excitation threshold voltage).

### Results

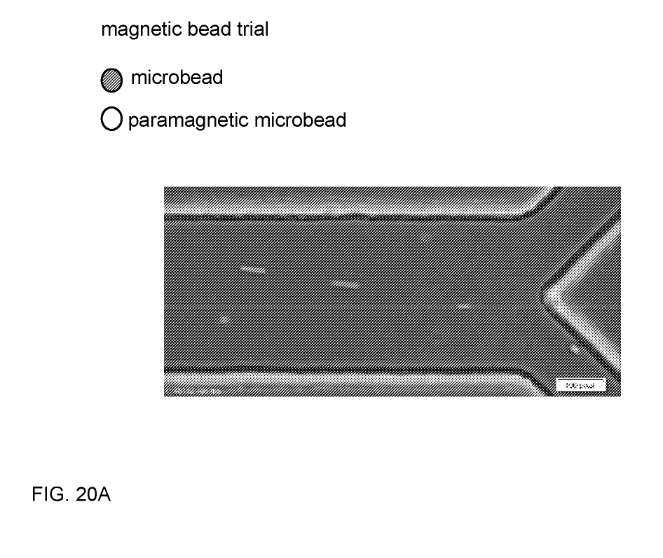

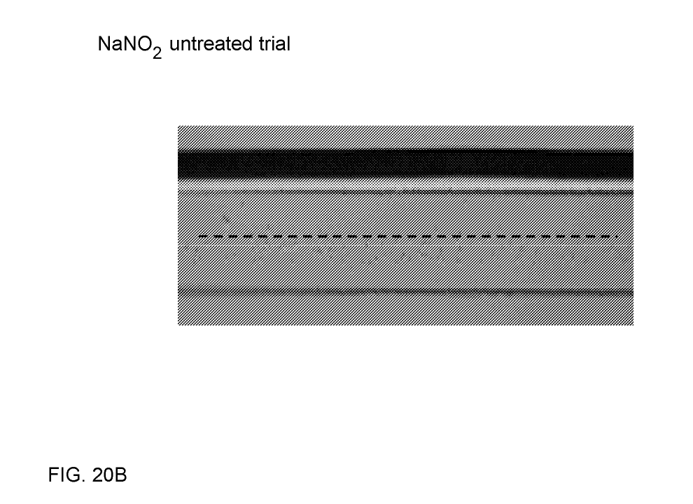

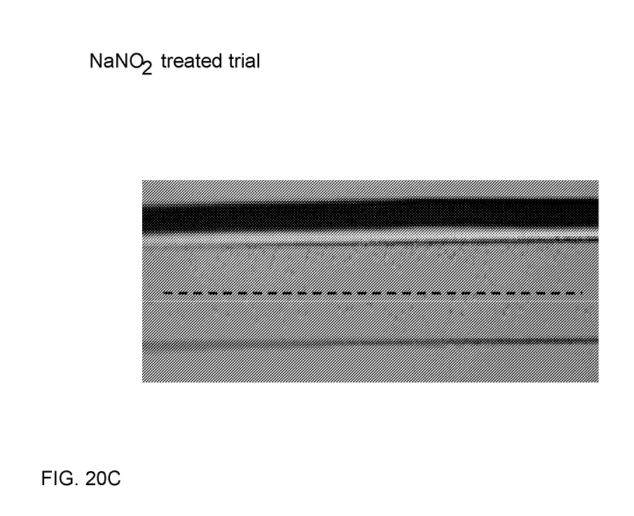

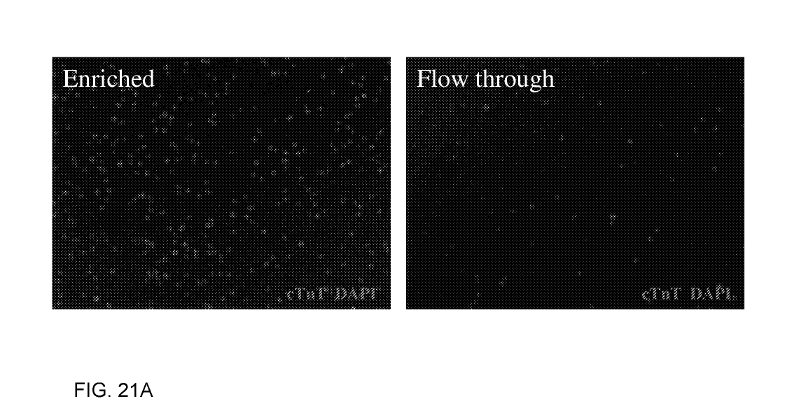

To demonstrate that the high magnetic field gradient around the nickel wire can influence trajectory of paramagnetic particles, model paramagnetic beads were used in the device, indicating clear movement of the particles towards the wire. Furthermore, two different conditions were tested again in the presence of the magnet and the nickel wire: (1) NaNO₂ untreated cells, and (2) NaNO₂ treated cells. Example results are shown in the images of FIGS. 20A-C. As shown in FIG. 20A, paramagnetic beads were found to project towards the high magnetic gradient, in contrast to non-magnetic fluorescent microbeads. In the presence of a magnetic field (resulting from a nickel wire and permanent magnet setup), untreated CM (i.e., non-paramagnetic cells) did not travel towards the nickel wire (FIG. 20B), while the treated cells (i.e., induced paramagnetic cells) did (FIG. 20C), consistent with the metMb induction in CMs upon NaNO₂ treatment.

### Enrichment of Ventricular Cardiomyocytes

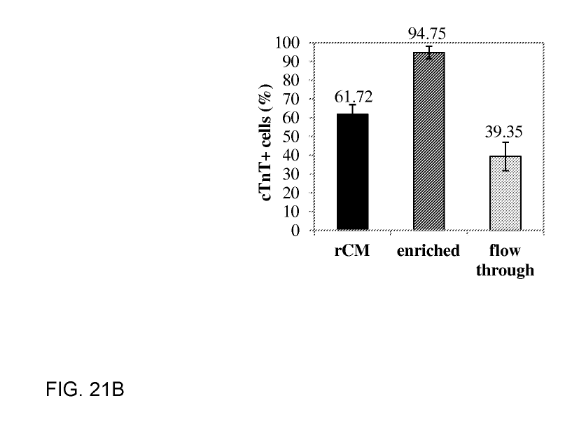

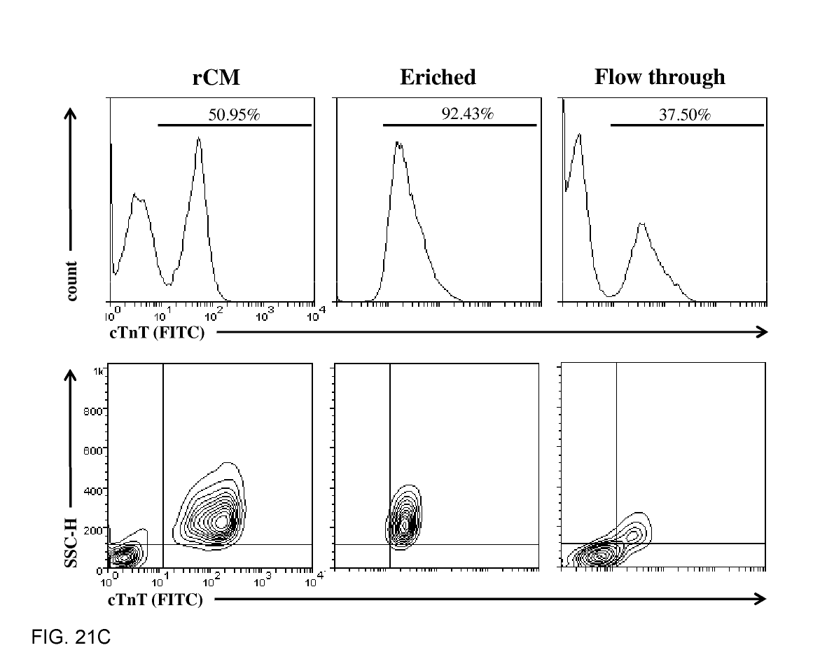

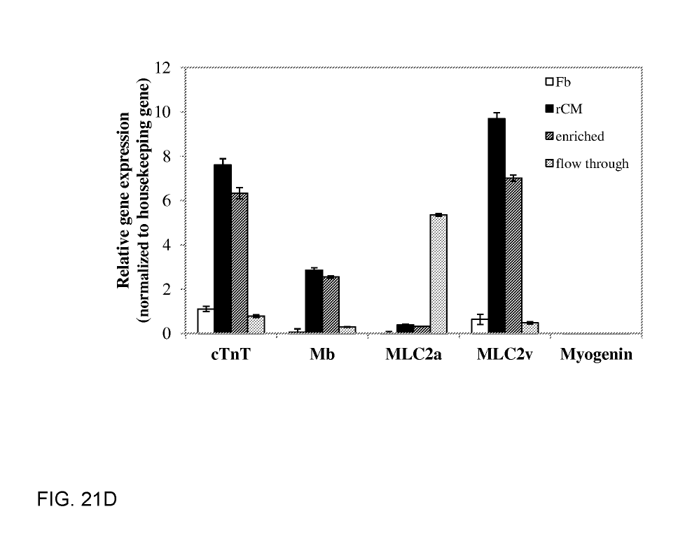

For cell separation experiments, the CM cell population was counted before and after passing through the example device with cTnT immunohistostaining. Representative images from the immunostained counts are shown in FIG. 21A. As shown in FIG. 21B, the input cell population initially contained 61.7±1.9% CMs. Cell population post separation was found to increase to 93.6±2.1% in the enriched collection, successfully demonstrated the feasibility of the example HGMS device for CM separation. The enriched stream analyzed was collected when the system stabilized, about 5 min into the flow initiation. The results were further verified through comparable FACS results obtained by pooling outputs from several separations, as shown in FIG. 21C. As seen in FIG. 21C, CM enrichment of greater than 92% was achieved.

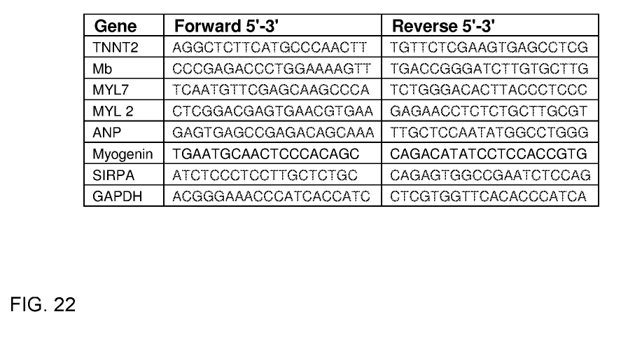

FIG. 21D shows example results of gene expression studies utilizing Myosin light chain markers specifically for atrium (MLC2a) and ventricle (MLC2v). The table in FIG. 22 shows the sequence listing of the qRT-PCR primers used. The results demonstrated that the enriched cells were composed of ventricular CMs, as indicated by near-exclusive expression of MLC2v and that the atrial CMs were in the flow through with near-exclusive MLC2a expression. The myocardium was free of myogenin, a gene marker for skeletal muscle cells.

### Expression of Myoglobin by Different Cardiomyocyte Subpopulations

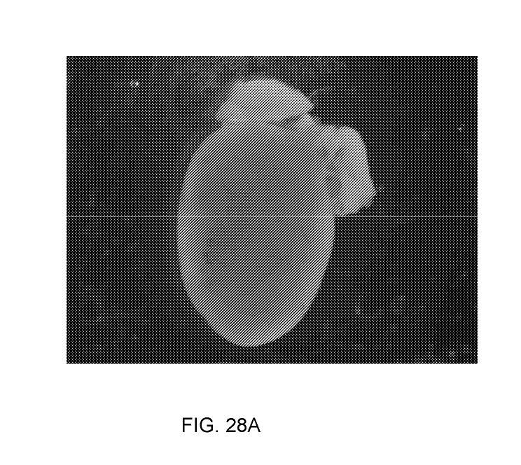

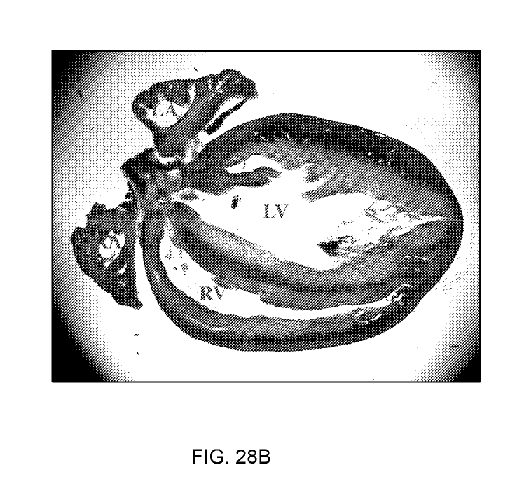

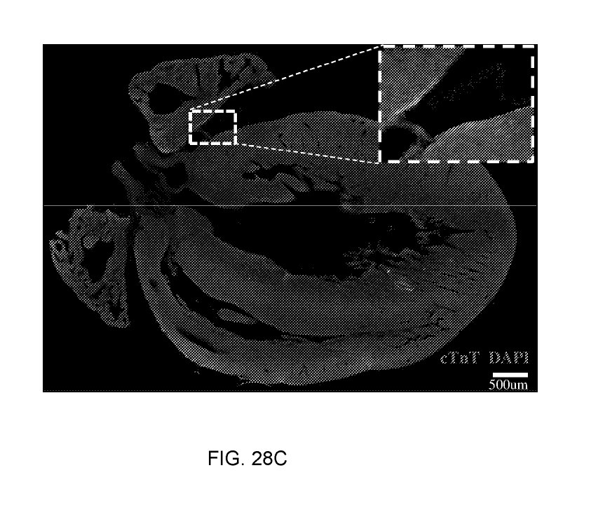

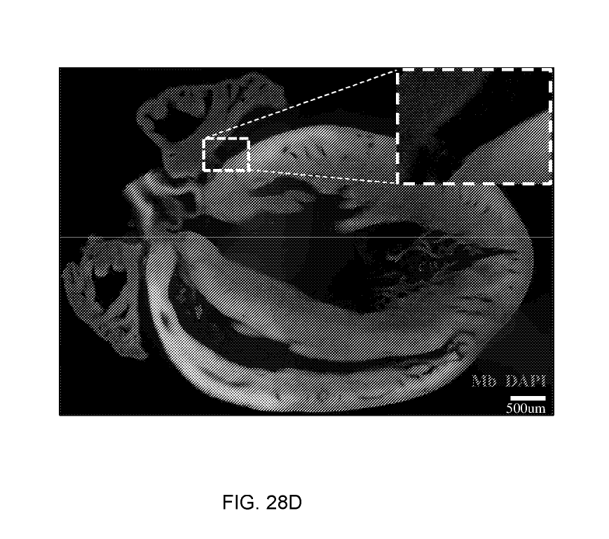

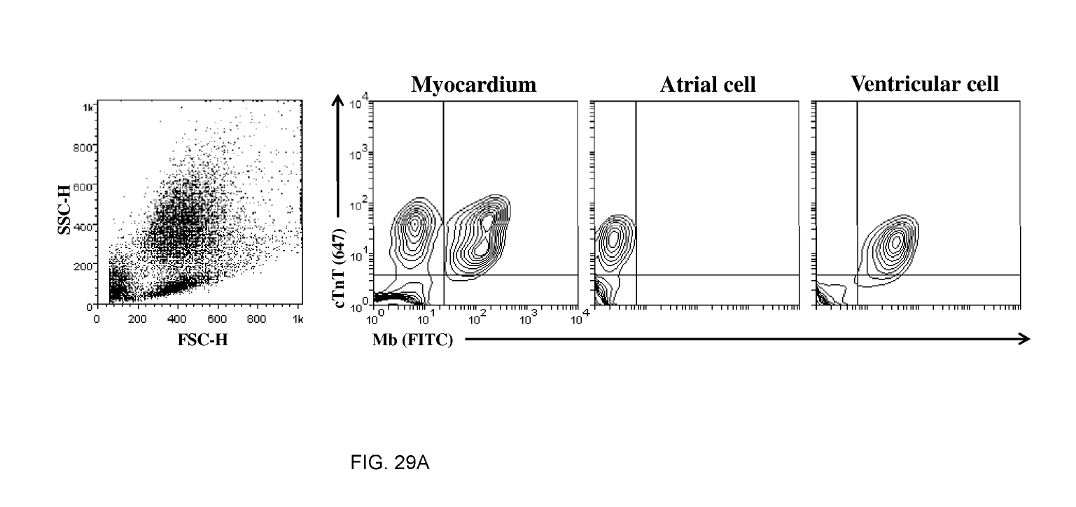

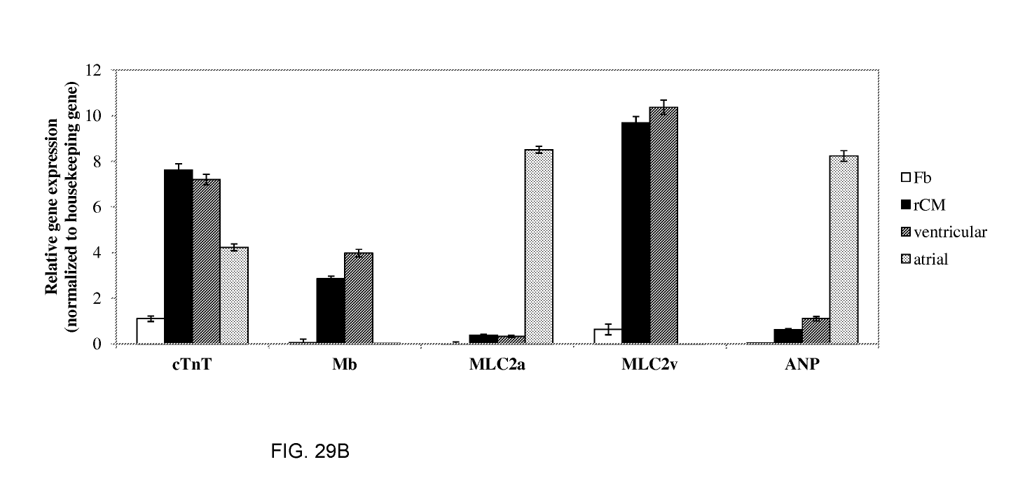

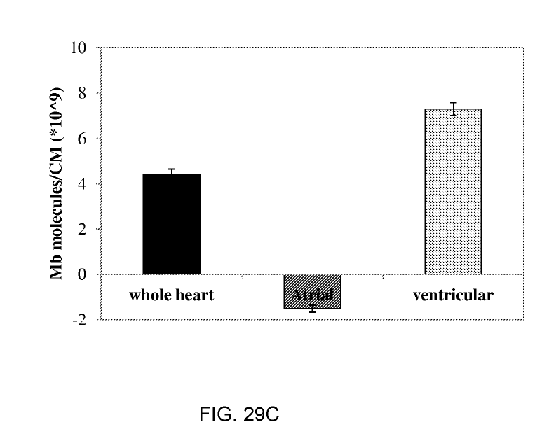

The expression of Mb by different subpopulations of CM was also studied. It was previously reported that there may be temporal and spatial expression of Mb in mouse embryo heart development [66]. To investigate this, sagittal cross-sections of neonatal rat hearts were immunostained. FIGS. 28A-28D show immunostained images illustrating the spatial expression of Mb in an example neonatal rat heart. FIG. 28A shows the heart fixed in 4% formalin prior to cryosection. FIG. 28B is a bright field transverse section of the heart with each chamber labeled (where LA=left atrium, RA=right atrium, LV=left ventricle, RV=right ventricle). FIG. 28C is an immunohisto stained image with cardiac marker cTnT, showing uniform expression of the marker in the atria and ventricles. FIG. 28D is an image with myoglobin staining, showing heterogeneous expression of Mb between the atria and ventricles, with a positive stain showing almost exclusively in the ventricles. The results found in staining were confirmed by FACS, gene expression and Mb ELISA quantification of physically dissected atrium and ventricle and their corresponding isolated cells shown (see FIGS. 29A-29C). FIG. 29A shows example results from a double staining of neonatal rat cardiac cells with Mb and cardiac marker cTnT, showing that the atrial CMs are negative for Mb protein expression. FIG. 29B shows example results from qRT-PCR, indicating that Mb gene expression is not found in the atrial cells. FIG. 29C is a chart showing example results from ELISA quantification of CM, showing 7.29×10⁹ Mb molecules/ventricular CM, in contrast to the absence of Mb in atrial cells.

The difference in spatial expression of Mb (and thus susceptibility to induced paramagnetism) in the heart may enable separation of cardiac cells, according to whether they are atrial or ventricular, using the methods and devices of the present disclosure.

### Expression of Myoglobins in Different Developmental Stages of Cardiomyocytes

The microfluidic separation technique disclosed herein may be useful for the separation of pluripotent stem cell-derived CM. To investigate this possible application, investigations were carried out to demonstrate that CM derived from pluripotent stem cells expressed myoglobin, and to determine whether the developmental stage of CMs could be identified based on Mb expression.

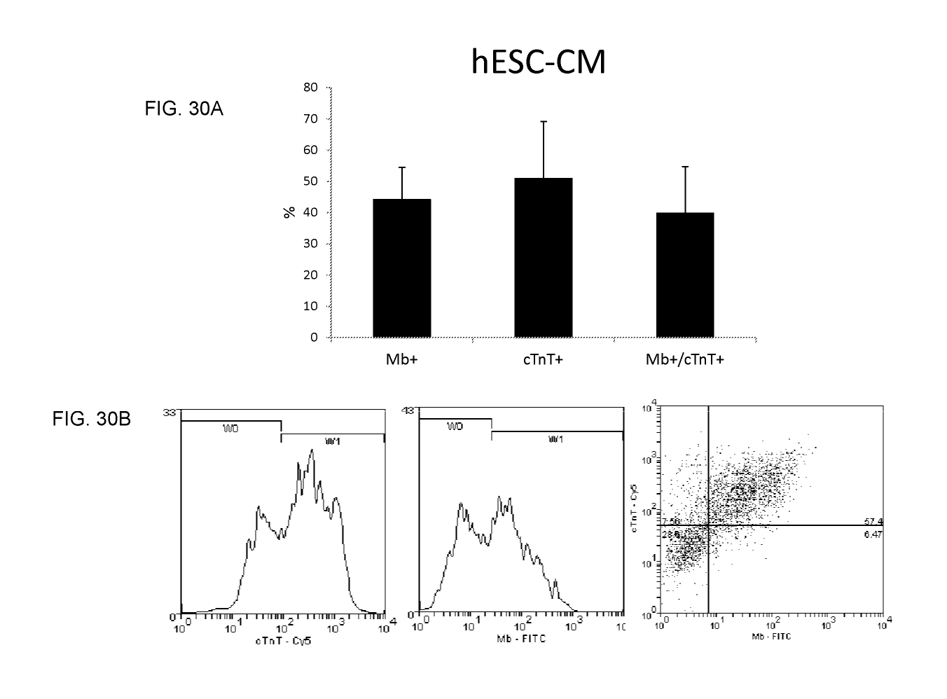

FIGS. 30A and 30B show example results illustrating the expression of cTnT and Mb in human ESC-derived CMs. In this example, human ESCs (Hes2 line) were differentiated as embryoid bodies using cytokine induction for 20 days. The embryoid bodies were dissociated and the cells were double stained for cTnT and Mb, and subjected to flow cytometry. FIG. 30A shows example results of average percentage of Mb-positive cells, cTnT-positive cells, and double positive cells. As indicated, most hESC-derived CMs express Mb (n=3). FIG. 30B shows some example flow cytometry plots.

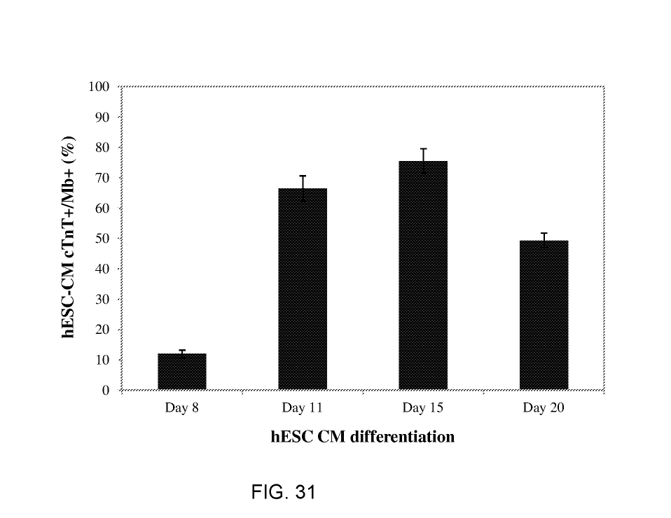

FIG. 31 is a chart illustrating cTnT and Mb expression in hESC-derived embryoid bodies, at different developmental stages. The chart shows example results from flow cytometry analysis. From day 8 to 11, a significant increase of double positive cells was found, indicating an expansion of cardiovascular lineages. Following day 11, the stabilization of percentage followed by a slight decrease may represent the maintenance and modulation of the CMs.

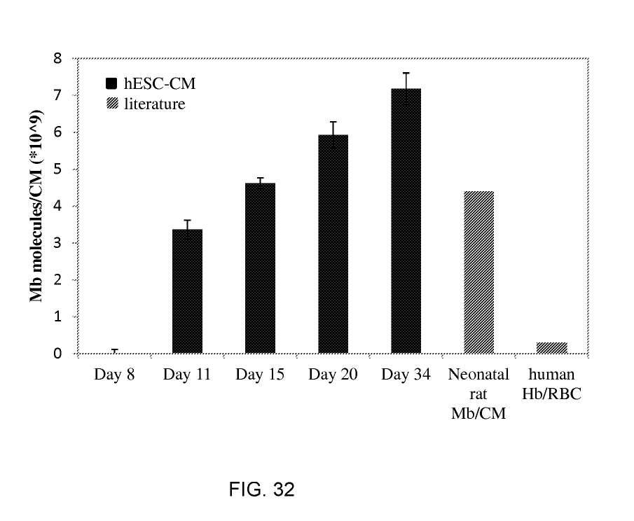

FIG. 32 is a chart illustrating Mb protein expression in hESC-derived embryoid bodies, at different developmental stages and compared to results reported in literature. The chart shows example results of kinetic Mb expression per CM in the embryoid bodies. ELISA combined with flow cytometry analysis were used to determine the average myoglobin content per cTnT and Mb double positive cells. Mb expression was found to increase along with the developmental stage.

The difference in expression of Mb (and thus susceptibility to induced paramagnetism) at different developmental stages may enable separation of CM cells, according to their developmental stage, using the methods and devices of the present disclosure.

### Cell Viability

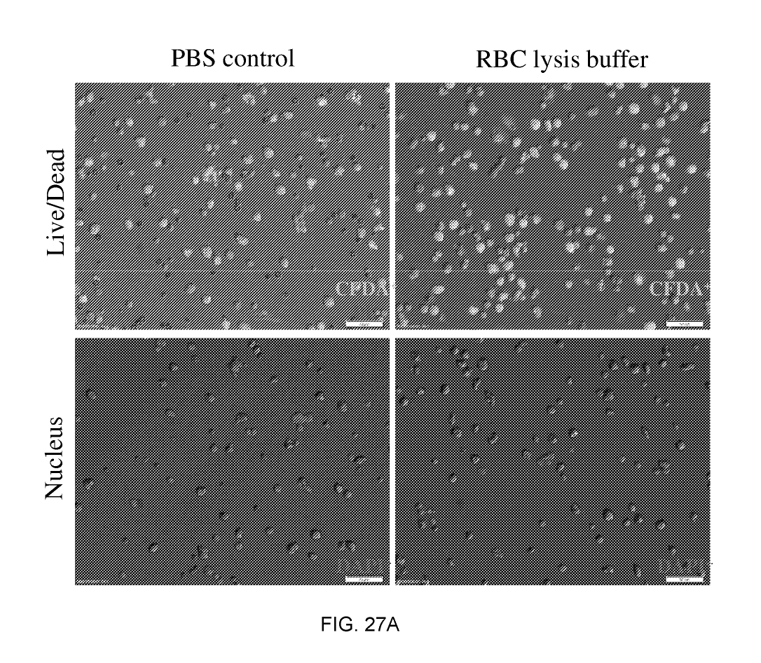

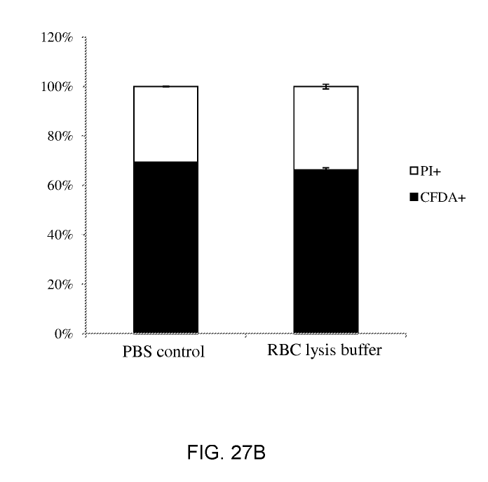

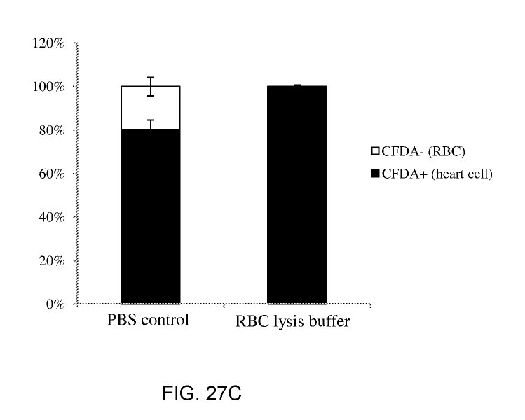

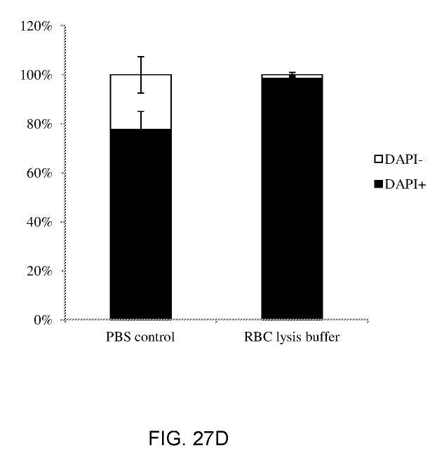

As discussed above, cytotoxicity studies with up to 50 mM sodium nitrite (NaNO₂) treatment of CMs show preserved cell viability and 3D culture functionality compared to PBS-treated control (see FIGS. 9A-9D). Since red blood cells (RBCs) also contain hemoglobin, which has been reported in the literature to be inducible to paramagnetic methemoglobin that can potentially interfere with myoglobin signal [8, 68, 69] and reduce target cell purity, the RBCs were effectively removed by the hemolyzing solution from the primary cell samples (>99%) while leaving the myocardium cells intact. FIGS. 27A-27D show example results illustrating effective removal of RBC from native heart isolates. FIG. 27A shows example images illustrating cyto-compatibility of the application of RBC lysis bugger to cardiac cells, using live/dead staining. The extent of RBC removal was studied by nucleus staining, taking advantage of the fact that mature RBCs are nuclei-free. FIG. 27B is a chart showing example results illustrating that the RBC lysis buffer treatment preserves cardiac cells and substantially eliminates RBC in about 5 min at room temperature, further shown by CFDA metabolic activity assay (see FIG. 27C) and DAPI stain (see FIG. 27D). In these figures, the symbol * indicates statistically significant differences (n=3; p<0.05)

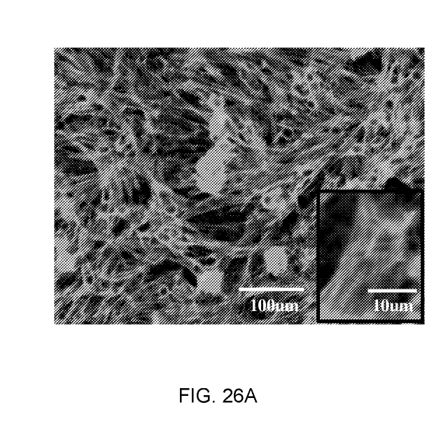

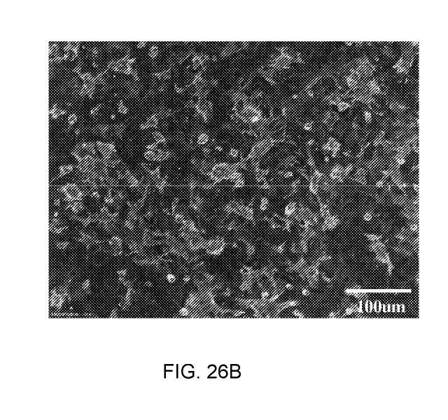

Example images showing cell viability as shown in FIGS. 26A (cells after separation using the example system) and 26B (cells without having been separated). Cell viability was maintained through the separation process, 95±1.6% compared to unsorted cells. Functional stimulation showed the cells beating synchronically at physiological frequency induced at low voltage.

To quantitatively evaluate the current separation process, system performance was analyzed. The example device was able to process 1.5×10⁵ cells/hr, achieving about 95% total recovery. The yield, defined as the % of the CMs captured in the enriched flow from the total input, was 38.4±3.5%. However, in the enriched stream, a high purity of 93.6±2.1% CMs was achieved and the functional efficiency, defined as the % of the target Mb containing paramagnetic induced ventricular CMs captured from the original cell input was 95.6±2.7%.

### Discussion

HGMS was first used in the early 1980s for removal of contaminants from waste water or extracting precious metals [71]. This phenomenon has recently been applied to biological systems such as the separation of red blood cells from blood. The present disclosure applies a similar approach to separation of CMs. The small magnetic susceptibility of induced-paramagnetic CMs required microscale HGMS to enable efficient cell enrichment.

Magnetic force is determined by both the magnetic field strength for induction and the field gradient. Therefore, magnetic force may be increased by using a stronger magnetic field and/or a higher field gradient. Using a permanent magnet with stable field strength and using the available strength of commercially available magnets, the gradient was increased to obtain strong magnetic forces acting on weakly paramagnetic CMs.

Microscale HGMS may be able to achieve a magnetic field gradient of about 10³ to about 10⁴ T/m [18]. Thus, efforts were made to microfabricate a ferromagnetic element integrated within a microfluidic device for CM separation.

The magnetic field also tends to dampens quickly away from the magnetic element because of the high magnetic gradient. From mathematical modeling studies, comparing the CMs projection length required as a function of CM height in channel and distance away from the wire center, distance from the wire demonstrated a more dominant and pronounced effect in determining the magnetic wire length required for cell capture. Therefore, the ability to introduce an oil droplet was integrated into the example device designed to facilitate positioning CMs in closer proximity to the field concentrator, hence closer to the high magnetic gradient.

It was also found that CM separation was more efficient after steady state flow was attained. Therefore, enriched and flow-through fractions were collected after steady state separation was attained, about five minutes into the separation process.

The literature has reported a spatial and temporal expression of Mb in the mouse embryo heart [66]. Early in the developmental stage, Mb is first expressed exclusively in the ventricle, followed by expression in the atrium in the adult murine heart. The findings of the disclosed example studies show analogy in the spatial effect of Mb expression in the neonatal rat. Ventricular CMs from neonatal rat myocardium with Mb were highly enriched, demonstrating the ability to differentially capture a particular subpopulation. Further exploiting the kinetic of Mb expression may present opportunities for CM subpopulation separation, such as by multi-outlet design or sequential module format.

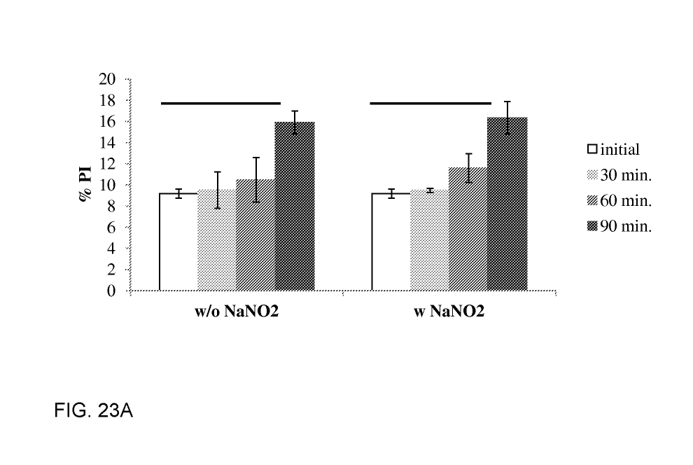

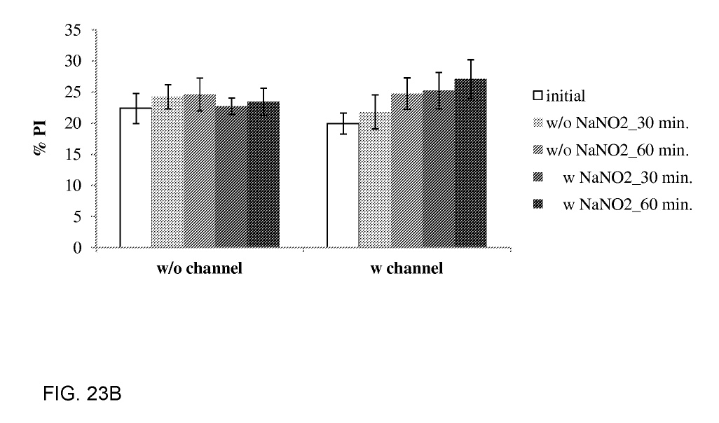

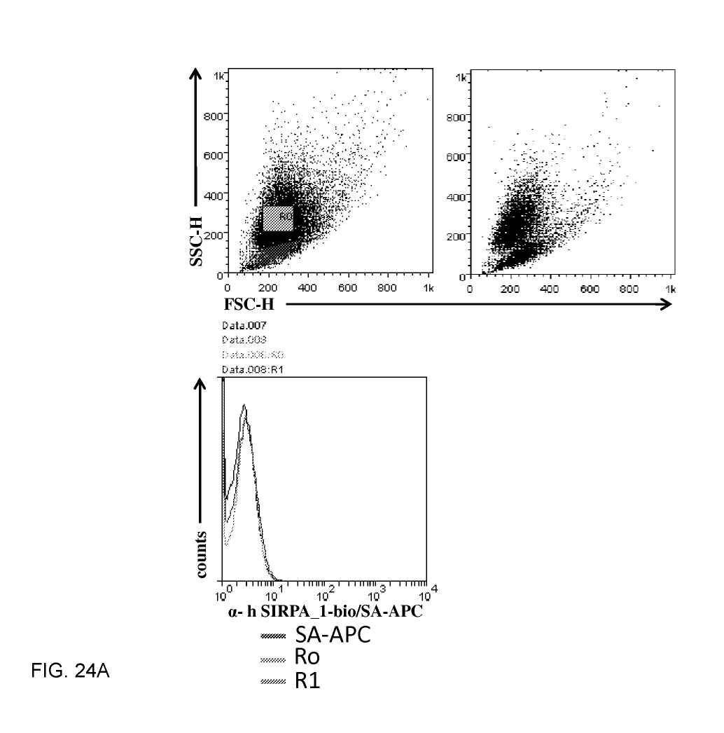

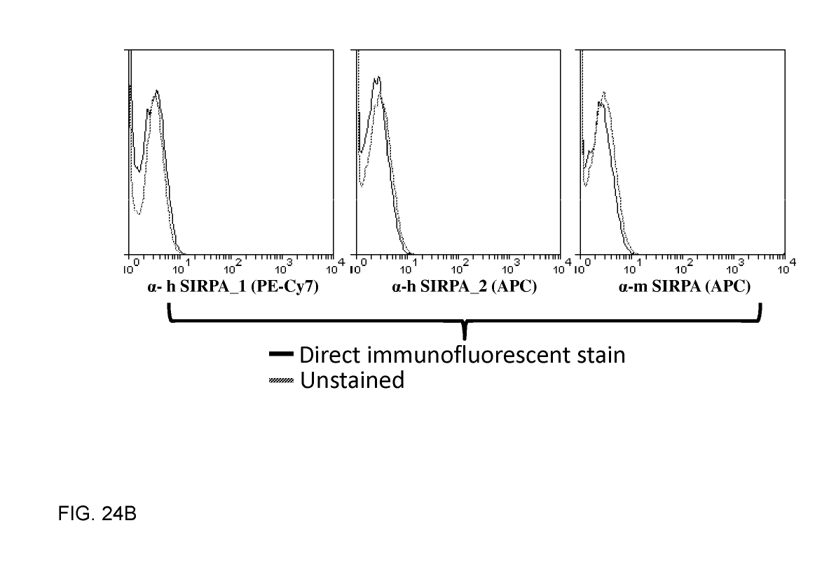

FIGS. 23A and 23B show that the viability of CMs is unaffected by treatment with NaNO₂ and by the separation process. Some diminishing of viability was found at room temperature after 1 hr. When separation was performed within this time frame, there was minimal cell loss under the moderate flow rate and single channel design. In contrast to conventional magnetic and flow-activated cell sorting where cell loss occurred due to large separation reservoir or cell death from high shear, the disclosed separation process may be more efficient in preserving cell number and viability.

In addition, while conventional magnetic activated cell sorting (MACS) enrichment typically varies as a function of the target antigen expression level, the design and operational parameters of the example device are versatile and may be custom fitted according to the properties of the target particles.

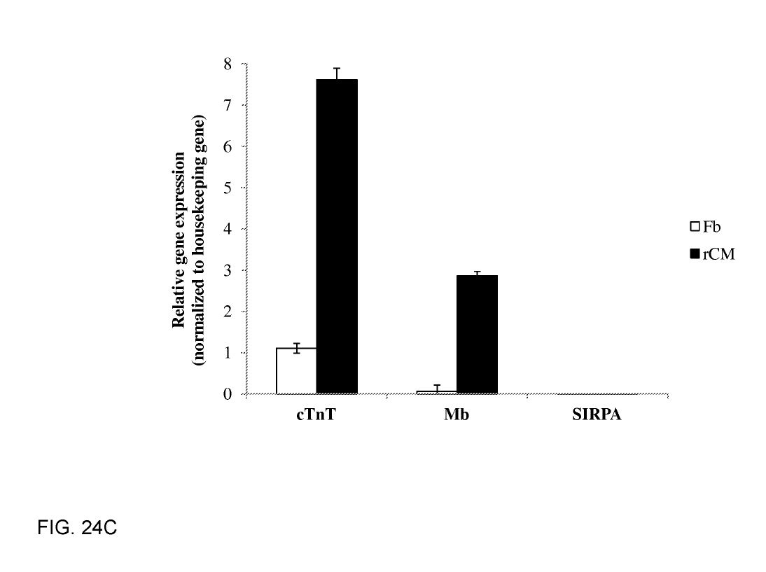

The activity of the endogenous metMb reductase regenerates Mb from metMb upon removal of NaNO₂ post separation. Furthermore, since Mb is conserved in all heart muscle cells, the approach is cross-species transferable. Compared to SIRPA cardiac surface marker, present on human CM but not detected on mouse ESC-derived CMs by antibody staining [4], there is an absence of SIRPA on neonatal rat CMs (see FIGS. 24A-24C). FIG. 24A shows example of flow cytometric analysis of neonatal rat CM, where cells were stained with SIRPA-bio/SA-SPC. FIG. 24B shows example results of SIRPA-PE-Cy7 and SIRPA-APC staining, compared to 2^{nd} Ab negative control and unstained control. No positive SIRPA cells were detected, suggesting that neonatal rat CM do not express SIRPA. FIG. 24C shows that qRT-PCR detection of SIRPA in rat CMs was also negative. The example device thus may provide a more universal method for CM separation.

The present disclosure provides methods and devices suitable for clinically viable CM purification. The ability to exploit the native inducible paramagnetic properties of CM to be utilized for separation further may offer clinically relevant highly enriched CMs. The present disclosure may provide expanding opportunities for cardiac tissue engineering and/or regenerative medicine applications.

Since Mb is present in CMs across species and throughout the developmental stages, the separation of CMs by magnetic means may not only be expandable across species, but also extendable to include cells early in the CM lineage. The power of an engineered solution, such as described herein, may lie in its versatile technical parameters and flexible designs. The disclosed device may be a stand-alone system or may be usable in conjunction with conventional separation methods. Furthermore, combined with the specific expression pattern of Mb in embryonic myogenesis, the present disclosure may be useful for distinctly separating specific CM subtype based on its Mb content.

Although the present disclosure discusses the separation of mouse CMs, this disclosure may also be used to separate human CMs.

Although the above examples describe devices and methods for separation of CMs from other cells and biological material, it should be understood that the disclosed methods and devices may be used for label-free separation of other biological and non-biological material using a magnetic field. The dimensions and configurations, as well as operating parameters of the device may be adjusted to suit different applications (e.g., larger diameters and higher flow rate for larger cells), as appropriate. Where appropriate, different techniques may be used to impart a paramagnetic property on the target material. In other cases, the target material may be sufficiently paramagnetic from the start.

The disclosed methods and systems may be used for separation of other biological and non-biological target materials. For example, the disclosed methods and systems, with suitable modifications, may be used for label-free separation of skeletal myoblasts, erythrocytes and smooth muscle cells. The disclosed methods and systems may also be useful for enriching CMs, skeletal myoblasts, erythrocytes and smooth muscle cells of different maturity.

The disclosed methods and systems may be useful in conjunction with magnetic antibody and micro- and/or nanoparticle labeling for enrichment of cells based on expression of surface markers (e.g. for enrichment of CD34+ cells from the whole cord blood), due to the high sensitivity that may be achieved using the present disclosure.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

### REFERENCES

1. Soonpaa, M. H. and L. J. Field, Survey of studies examining mammalian cardiomyocyte DNA synthesis. Circulation Research, 1998. 83(1): p. 15-26.
2. Laflamme, M. A. and C. E. Murry, Regenerating the heart. Nat Biotechnol, 2005. 23(7): p. 845-56.
3. Dimmeler, S., A. M. Zeiher, and M. D. Schneider, Unchain my heart: the scientific foundations of cardiac repair. J Clin Invest, 2005. 115(3): p. 572-83.
4. Dubois, N. C., et al., SIRPA is a specific cell-surface marker for isolating cardiomyocytes derived from human pluripotent stem cells. Nat Biotechnol 29, (2011), 1011-U1082.
5. Hattori, F., et al., Nongenetic method for purifying stem cell-derived cardiomyocytes. Nat Methods, 2009. 7(1): p. 61-6.
6. Murthy, S. K., Sethu, P., Vunjak-Novakovic, G., Toner, M. & Radisic, M. (2006) Biomed Microdevices 8, 231-7.
7. Zborowski M, Ostera G R, Moore L R, Milliron S, Chalmers J J, Schechter A N (2003) Red blood cell magnetophoresis. Biophys J 84:2638-2645
8. Han K, Frazier A B (2004) Continuous magnetophoretic separation of blood cells in microdevice format. J ApplPhys 96:5797-5802
9. Han K, Frazier A B (2005) Diamagnetic capture mode magnetophoretic microseparator for blood cells. J Microelectromech Syst 14:1422-1431
10. Han K, Frazier A B (2006) Paramagnetic capture mode magnetophoretic microseparator for high efficiency blood cell separations. Lab Chip 6:265-273
11. Huang R, Barber T A, Schmidt M A, Tompkins R G, Toner M, Bianchi D W, Kapur R, Flejter W L (2008) A microfluidics approach for the isolation of nucleated red blood cells (NRBC) from the peripheral blood of pregnant women. PrenatDiagn 28:892-899
12. Radisic M, Park H, Martens T P, Salazar-Lazaro J E, Geng W, Wang Y, Langer R, Freed L E, Vunjak-Novakovic G. Pre-treatment of synthetic elastomeric scaffolds by cardiac fibroblasts improves engineered heart tissue. J Biomed Mater Res A (2007).
13. Qiu Y, Sutton L, Riggs A F. Identification of myoglobin in human smooth muscle. J Biol Chem 1998; 273:23426-23432.
14. Song H, Yoon C, Kattman S J, Dengler J, Masse S, Thavaratnam T, Gewarges M, Nanthakumar K, Rubart M, Keller G M, Radisic M, Zandstra P W. Regenerative Medicine Special Feature: Interrogating functional integration between injected pluripotent stem cell-derived cells and surrogate cardiac tissue. Proc Natl Acad Sci USA 2009.
15. Radisic M, Euloth M, Yang L, Langer R, Freed L E, Vunjak-Novakovic G. High-density seeding of myocyte cells for cardiac tissue engineering. Biotechnol Bioeng 2003; 82:403-414.
16. Yang L, Soonpaa M H, Adler E D, Roepke T K, Kattman S J, Kennedy M, Henckaerts E, Bonham K, Abbott G W, Linden R M, Field L J, Keller G M. Human cardiovascular progenitor cells develop from a KDR+ embryonic-stem-cell-derived population. Nature 2008; 453:524-528.
17. Radisic M, Yang L, Boublik J, Cohen R J, Langer R, Freed L E, Vunjak-Novakovic G. Medium perfusion enables engineering of compact and contractile cardiac tissue. Am J Physiol Heart Circ Physiol 2004; 286:H507-516.
18. Svoboda J, 2004, Magnetic techniques for the treatment of materials, Kluwer Academic Publishers, Dordrecht, the Netherlands. (2004)
19. Perin, E. C. et al. in American Heart Association (Orlando, Fla., 2011).
20. Melville, D., Paul, F. & Roath, S. Fractionation of Blood Components Using High Gradient Magnetic Separation. IEEE TRANSACTIONS ON MAGNETICS MAG-18 (1982).
21. Radisic, M. et al. Functional assembly of engineered myocardium by electrical stimulation of cardiac myocytes cultured on scaffolds. Proceedings of the National Academy of Sciences of the United States of America 101, 18129-18134 (2004).
22. Costantini, D. L. et al. The homeodomain transcription factor Irx5 establishes the mouse cardiac ventricular repolarization gradient. Cell 123, 347-58 (2005).
23. Zandstra, P. W. et al. Scalable production of embryonic stem cell-derived cardiomyocytes. Tissue Eng 9, 767-78 (2003).
24. Tandon, N. et al. Electrical stimulation systems for cardiac tissue engineering. Nat Protoc 4, 155-73 (2009).
25. Papadopoulos, S., Jurgens, K. D. & Gros, G. Diffusion of myoglobin in skeletal muscle cells—dependence on fibre type, contraction and temperature. Pflugers Arch 430, 519-25 (1995).
26. Schenkman, K. A., Marble, D. R., Burns, D. H. & Feigl, E. O. Myoglobin oxygen dissociation by multiwavelength spectroscopy. J Appl Physiol 82, 86-92 (1997).
27. Garry, D. J., Kanatous, S. B. & Mammen, P. P. Emerging roles for myoglobin in the heart. Trends Cardiovasc Med 13, 111-6 (2003).
28. Chalmers J J, Haam S, Zhao Y, McCloskey K, Moore L, Zborowski M, Williams P S. Quantification of cellular properties from external fields and resulting induced velocity: Cellular hydrodynamic diameter. Biotechnol. Bioeng. 1999 September vol. 64(no 5):509-518.
29. Zhang, J., Wilson, G. F., Soerens, A. G., Koonce, C. H., Yu, J., Palecek, S. P., Thomson, J. A. & Kamp, T. J. (2009) Circ Res 104, e30-41.
30. Pethig, R. (2010) Biomicrofluidics 4.
31. Zhang, B., Green, J. V., Murthy, S. K. & Radisic, M. (2012) PLoS One 7, e37619.
32. Iyer, R. K., Chiu, L. L. & Radisic, M. (2009) J Biomed Mater Res A 89, 616-31.
33. Kendrew, J. C., Bodo, G., Dintzis, H. M., Parrish, R. G., Wyckoff, H. & Phillips, D. C. (1958) Nature 181, 662-6.
34. George, P., Beetlestone, J. & Griffith, J. S. (1964) Reviews of Modern Physics 36, 441-&.
35. Han, K. H. & Frazier, A. B. (2006) IEE Proc Nanobiotechnol 153, 67-73.
36. Ma, Q., Chen, C., Wei, S., Chen, C., Wu, L. F. & Song, T. (2012) Biomicrofluidics 6, 24107-2410712.
37. Deen, W. M. (1998) Analysis of Transport Phenomena (Oxford University Press, New York).
38. Duranski, M. R., Greer, J. J., Dejam, A., Jaganmohan, S., Hogg, N., Langston, W., Patel, R. P., Yet, S. F., Wang, X., Kevil, C. G., Gladwin, M. T. & Lefer, D. J. (2005) J Clin Invest 115, 1232-40.
39. Lefer, D. J. (2009) Arch Pharm Res 32, 1127-38.
40. Doeller, J. E. & Wittenberg, B. A. (1991) Am J Physiol 261, H53-62.
41. Bailey, J. R. & Driedzic, W. R. (1988) J Exp Biol 135, 301-15.
42. Hagler, L., Coppes, R. I., Jr. & Herman, R. H. (1979) J Biol Chem 254, 6505-14.
43. Brown, M. A., Iyer, R. K. & Radisic, M. (2008) Biotechnol Prog 24, 907-20.
44. Naito, H., Melnychenko, I., Didie, M., Schneiderbanger, K., Schubert, P., Rosenkranz, S., Eschenhagen, T. & Zimmermann, W. H. (2006) Circulation 114, I72-8.
45. Liang, L., Zhu, J. & Xuan, X. (2012) Biomicrofluidics 5, 34110-3411013.
46. Plouffe, B. D., Lewis, L. H. & Murthy, S. K. (2011) Biomicrofluidics 5, 13413.
47. Donolato, M., Dalslet, B. T. & Hansen, M. F. (2012) Biomicrofluidics 6, 24110-241106.
48. Willmott, G. R., Platt, M. & Lee, G. U. (2012) Biomicrofluidics 6, 14103-1410315.
49. Vunjak-Novakovic, G., Lui, K. O., Tandon, N. & Chien, K. R. Bioengineering heart muscle: a paradigm for regenerative medicine. Annu Rev Biomed Eng 13, 245-267 (2011).
50. Passier, R., van Laake, L. W. & Mummery, C. L. Stem-cell-based therapy and lessons from the heart. Nature 453, 322-329 (2008).
51. Wu, J., Zeng, F. Q., Weisel, R. D. & Li, R. K. Stem Cells for Cardiac Regeneration by Cell Therapy and Myocardial Tissue Engineering. Adv Biochem Eng Blot 114, 107-128 (2009).
52. Caspi, O., et al. Transplantation of human embryonic stem cell-derived cardiomyocytes improves myocardiol performance in infrcted rat hearts. J Am Coll Cardiol 50, 1884-1893 (2007).
53. Zwi, L., et al. Cardiomyocyte Differentiation of Human Induced Pluripotent Stem Cells. Circulation 120, 1513-1523 (2009).
54. Zhu, W. Z., Hauch, K. D., Xu, C. & Laflamme, M. A. Human embryonic stem cells and cardiac repair. Transplant Rev (Orlando) 23, 53-68 (2009).
55. Barile, L., et al. Cardiac stem cells: isolation, expansion and experimental use for myocardial regeneration. Nat Clin Pract Cardiovasc Med 4 Suppl 1, S9-S14 (2007).
56. McIntyre, C. A., Flyg, B. T. & Fong, T. C. Fluorescence-activated cell sorting for CGMP processing of therapeutic cells. BioProcess International 8, 44-53 (2010).
57. Xu, C., Police, S., Hassanipour, M. & Gold, J. D. Cardiac bodies: a novel culture method for enrichment of cardiomyocytes derived from human embryonic stem cells. Stem Cells Dev 15, 631-639 (2006).
58. Pretlow, T. G., 2nd, Glick, M. R. & Reddy, W. J. Separation of beating cardiac myocytes from suspensions of heart cells. Am J Pathol 67, 215-226 (1972).
59. Klug, M. G., Soonpaa, M. H., Koh, G. Y. & Field, L. J. Genetically selected cardiomyocytes from differentiating embryonic stem cells form stable intracardiac grafts. J Clin Invest 98, 216-224 (1996).
60. Muller, M., et al. Selection of ventricular-like cardiomyocytes from ES cells in vitro. Faseb J 14, 2540-2548 (2000).
61. Anderson, D., et al. Transgenic enrichment of cardiomyocytes from human embryonic stem cells. Mol Ther 15, 2027-2036 (2007).
62. Huber, I., et al. Identification and selection of cardiomyocytes during human embryonic stem cell differentiation. Faseb J 21, 2551-2563 (2007).
63. Shimizu, K., et al. Construction of multi-layered cardiomyocyte sheets using magnetite nanoparticles and magnetic force. Biotechnology and Bioengineering 96, 803-809 (2007).
64. Moretti, A., et al. Multipotent embryonic Isl1(+) progenitor cells lead to cardiac, smooth muscle, and endothelial cell diversification. Cell 127, 1151-1165 (2006).
65. Uosaki, H., et al. Efficient and Scalable Purification of Cardiomyocytes from Human Embryonic and Induced Pluripotent Stem Cells by VCAM1 Surface Expression. Plos One 6 (2011).
66. Kanatous, S. B. & Mammen, P. P. A. Regulation of myoglobin expression. J Exp Biol 213, 2741-2747 (2010).
67. Beetlestone, J. & George, P. A Magnetochemical Study of Equilibria between High and Low Spin States of Metmyoglobin Complexes. Biochemistry 3, 707-714 (1964).
68. Melville, D., Paul, F. & Roath, S. High Gradient Magnetic Separation of Red-Cells from Whole-Blood. Ieee T Magn 11, 1701-1704 (1975).
69. Owen, C. S. High Gradient Magnetic Separation of Erythrocytes. Biophys J 22, 171-178 (1978).
70. Birss, R. R. & Gerber, R. High gradient magnetic separation. Research Studies Press (1983).
71. Mitchell, R., Bitton, G. & Oberteuffer, J. A. High Gradient Magnetic Filtration of Magnetic and Non-Magnetic Contaminants from Water. Separ Purif Method 4, 267-303 (1975).

1. A device for label-free separation of material comprising:
a fluid-filled settling chamber for settling material by gravity, the settling chamber having an inlet for introducing a fluid mixture comprising a target material and at least one non-target material, the target material having a paramagnetic property;
wherein a magnetic field is applied to the settling chamber sufficient to impede gravitational settling of the target material and not affect gravitational settling of the non-target material, in order to separate the target material from the non-target material.

2. The device of claim 1 further comprising a magnetic field source for applying the magnetic field to the settling chamber.

3. The device of claim 2 wherein the magnetic field source comprises a metal coil wound about the settling chamber and at least one magnet for applying the magnetic field to the settling chamber.

4. The device of claim 1 wherein the settling chamber comprises a vertically-oriented column and the inlet is positioned at an upper portion of the column.

5. The device of claim 1 further comprising at least one pump for pumping the fluid mixture into the settling chamber at a steady rate.

6. The device of claim 1 wherein the settling chamber comprises an outlet for removal of the settled non-target material.

7. The device of claim 1 wherein the settling chamber comprises a second inlet for introducing fluid flow into the settling chamber against gravity.

8. The device of claim 7 further comprising at least one pump for causing fluid flow in the settling chamber through the second inlet.

9. The device of claim 1 wherein the settling chamber is a cylindrical column.

10. The device of claim 9 wherein the settling chamber has a diameter in the range of about 10-10000 μm.

11. The device of claim 10 wherein the settling chamber has a diameter in the range of about 300-1200 μm.

12. The device of claim 9 wherein the settling chamber has a length of about 1-1000 mm.

13. The device of claim 12 wherein the settling chamber has a length of about 30 mm.

14. The device of claim 1 wherein the applied magnetic field has a field strength of about 0.01-30 T.

15. The device of claim 14 wherein the applied magnetic field has a field strength of at least about 1.15 T.

16. A method for label-free separation of material, the method comprising:
introducing into a fluid-filled settling chamber a fluid mixture comprising a target material and at least one non-target material, the target material having a paramagnetic property;
applying a magnetic field to the settling chamber;
allowing the non-target material and the target material to settle by gravity, wherein gravitational settling of the target material is impeded by the magnetic field; and
separating the target material from the non-target material.

17. The method of claim 16 further comprising introducing fluid flow into the settling chamber against gravity, to remove the non-target material, in order to separate the target material from the non-target material, wherein the magnetic field is sufficient to attract the target material towards internal walls of the settling chamber and away from most of the fluid flow.

18. The method of claim 17 wherein the introduced fluid flow is at a flow rate similar to a gravitational settling rate of the target material.

19. The method of claim 16 wherein the target material comprises cardiomyocytes and the cardiomyocytes are provided with the paramagnetic property through treatment with NaNO₂.

20. The method of claim 16 wherein the settling chamber is a cylindrical column.
